(19) United States
(12) Patent Application Publication
(10) Pub. No.: US 2024/0040648 A1
(43) Pub. Date: Feb. 1, 2024

(54) FLEXIBLE ANTENNA PORT MAPPING FOR RETAINING CHANNEL RECIPROCITY IN FULL-DUPLEX WIRELESS COMMUNICATION SYSTEMS

(71) Applicant: Fraunhofer-Gesellschaft zur Förderung der angewandten Forschung e.V., München (DE)

(72) Inventors: Ramez ASKAR, Berlin (DE); Thomas HAUSTEIN, Berlin (DE); Wilhelm KEUSGEN, Berlin (DE); Michael PETER, Berlin (DE)

(21) Appl. No.: 18/481,813

(22) Filed: Oct. 5, 2023

Related U.S. Application Data
(63) Continuation of application No. PCT/EP2022/058654, filed on Mar. 31, 2022.

(30) Foreign Application Priority Data
Apr. 7, 2021 (EP) 21167218.3

(51) Int. Cl. H04W 76/15; H04L 5/14

(52) U.S. Cl. CPC H04W 76/15; H04L 5/1469

(57) ABSTRACT

An apparatus for a wireless communication network communicates with one or more entities in the wireless communication network using a plurality of different communication channels. The plurality of communication channels includes at least a first communication channel and a second communication channel. The apparatus transmits on one of the first and second communication channels and, at the same time, receives on the other one of the first and second communication channels. For exploiting a reciprocity of the first and second communication channels, the apparatus switch between simultaneously transmitting over the first communication channel and receiving over the second communication channel, and simultaneously transmitting over the second communication channel and receiving over the first communication channel.

### CROSS-REFERENCE TO RELATED APPLICATIONS

This application is a continuation of copending International Application No. PCT/EP2022/058654, filed Mar. 31, 2022, which is incorporated herein by reference in its entirety, and additionally claims priority from European Application No. 21167218.3, filed Apr. 7, 2021, which is also incorporated herein by reference in its entirety.

The present application concerns the field of wireless communications, more specifically a full-duplex transceiver apparatus, which may be included in one or more entities of a wireless communication network or system. Embodiments relate to a full-duplex transceiver apparatus retaining reciprocity properties by utilizing a switched antenna approach. Further embodiments relate to a flexible antenna port mapping.

### BACKGROUND OF THE INVENTION

FIG. 1 is a schematic representation of an example of a terrestrial wireless network 100 including, as is shown in FIG. 1(a), the core network 102 and one or more radio access networks RAN₁, RAN₂, . . . RAN_{N}. FIG. 1(b) is a schematic representation of an example of a radio access network RAN n that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(b) shows an exemplary view of five cells, however, the RANₙ may include more or less such cells, and RANₙ may also include only one base station. FIG. 1(b) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(b) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 1121. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1(b) by the arrows pointing to “core”. The core network 102 may be connected to one or more external networks. The external network may be the Internet, or a private network, such as an Intranet or any other type of campus networks, e.g. a private WiFi or 4G or 5G mobile communication system. Further, some or all of the respective base station gNB₁ to gNB₅ may be connected, e.g. via the S1 or X2 interface or the XN interface in NR, with each other via respective backhaul links 116₁ to 116₅, which are schematically represented in FIG. 1(b) by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, carrying for example a master information block, MIB, and one or more of a system information block, SIB, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. Note, the sidelink interface may a support 2-stage SCI. This refers to a first control region containing some parts of the SCI, and optionally, a second control region, which contains a second part of control information.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix, CP, length. A frame may also consist of a smaller number of OFDM symbols, e.g. when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other IFFT-based signal with or without CP, e.g. DFT-s-OFDM. Other waveforms, like non-orthogonal waveforms for multiple access, e.g. filter-bank multicarrier, FBMC, generalized frequency division multiplexing, GFDM, or universal filtered multi carrier, UFMC, may be used. The wireless communication system may operate, e.g., in accordance with the LTE-Advanced pro standard, or the 5G or NR, New Radio, standard, or the NR-U, New Radio Unlicensed, standard.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the 5G or NR, new radio, standard.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. RSUs may have functionalities of BS or of UEs, depending on the specific network configuration. Other UEs may not be vehicular related UEs and may comprise any of the above-mentioned devices. Such devices may also communicate directly with each other, D2D communication, using the SL channels.

In a wireless communication network, like the one depicted in FIG. 1, different communication duplexing schemes may be implemented. There may be three duplexing schemes, two half-duplex, HD, schemes, e.g., a frequency division duplex, FDD, scheme and time division duplex, TDD, scheme, and a full-duplex, FD, scheme. FIG. 2 schematically illustrates the respective schemes, wherein FIG. 2(a) illustrates the HD FDD scheme, FIG. 2(b) illustrates the HD TDD scheme, and FIG. 2(c) illustrates the FD scheme. FIG. 2 illustrates the respective transceiver units and the resource allocations for an uplink, UL, transmission and a downlink, DL, transmission in the time and the frequency resources.

As is illustrated in FIG. 2(a), an HD FDD transceiver 200a comprises an antenna ANT, a transmitter chain or front-end TX and a receiver chain front-end RX. The antenna ANT and the transmit and receive chains are connected to a shared antenna via duplex filter DX including: The signal path between the transmit chain TX and the antenna ANT a bandpass filter BP_{TX} defining the transmission frequency band, and the signal path between the antenna and the receive chain RX includes the bandpass filter BP_{RX} defining the reception frequency band. The respective transmission and reception frequency bands are illustrated as the UL band and the DL band in the frequency domain which may be separated by a guard band G. The FDD scheme allows simultaneously transmitting and receiving in different frequency bands at the same time, as is illustrated by the UL and DL timeslots indicated for the time domain.

FIG. 2(b) illustrates a receiver 200b operating in accordance with the HD TDD scheme and including the antenna ANT and the transmit and receive chains or front-ends TX, RX which are coupled to the antenna via the switch S for selectively connecting the antenna to the transmit chain TX or to the receive chain RX. In accordance with the TDD scheme, the UL and DL transmissions are performed at separate timeslots as indicated in FIG. 2(b) for the time resources but at the same frequency band.

FIG. 2(c) illustrates a FD transceiver 200c also including the antenna ANT coupled via a self-interference cancellation circuit 204 to the transmit chain or front-end TX and to the receive chain or front-end RX. The self-interference cancellation circuit 204 is provided so as to reduce self-interference due to simultaneously transmitting and receiving via the antenna ANT. The transmit signal may be provided to the antenna via a circulator device 206, and a receive signal may be provided from the antenna to the receiver chain RX also via the circulator device 206. Since transmitting and receiving occurs at the same time, part of the transmit signal may be forwarded to the receive branch, and to suppress the self-interference the self-interference cancellation circuit 204 provides a SIC signal, namely the transmit signal, that is inverted and added to the signal in the receive branch so that the RX chain only receives the actual signal received at the antenna. The FD transmitter allows simultaneously transmitting in the same frequency band the uplink and downlink transmissions, as is indicated in the time/frequency resources in FIG. 2(c).

The FD scheme is a communication duplexing scheme that can double the spectral utilization and reduce latencies. In contrast to the conventional HD schemes, such as the above-described TDD and FDD schemes, the FD scheme enables a bidirectional communication link among several entities or nodes at the same time and over the same frequency band. The bidirectional communication link in HD schemes is enabled either by non-overlapped timeslots as in TDD systems or by two adjacent frequency bands as in FDD systems. As mentioned above, TDD systems use an RF switch to switch among transmission and reception states so that in accordance with the TDD scheme, at one instance of time, either transmitting or receiving is possible. The FDD scheme employs a steep RF duplex filter to prevent the receiver from saturation by concurrent transmit signals so that in accordance with a FDD scheme, transmission and reception is possible at the same time by utilizing two different frequency bands.

In the FD scheme, as mentioned above, transmission and reception is possible at the same time over the same frequency band so that the so-called interference cancellation, SIC, is needed to enable the bidirectional link because neither switches nor filters may be employed because otherwise the simultaneous transmission and reception at the same time in the same frequency band is not possible. SIC may rely on passive techniques and/or on active techniques. The passive techniques prevent the self-interference signal from entering the receive front-end or receive chain, for example by providing separate antennas for the transmission and for the reception. The active techniques, like the one briefly summarized in FIG. 2(c) use a negative version of the transmit signal that is added at the receiver front-end or RX chain to cancel the self-interference signal which may be done in the RF domain or in the digital domain.

The self-interference needs to be cancelled to the receiver noise floor level to exploit the full benefit of the full-duplex scheme and doubling the frequency range. In practical systems, the SIC may not be achievable completely in the digital domain as the self-interference signal may cause an inevitable receiver front-end saturation. Therefore, the SIC also needs to be achieved in the radio-frequency, RF, domain. Stated differently, the self-interference signal needs to be suppressed sufficiently, not necessarily completely, before it enters the receiver front-end. FIG. 3 schematically indicates a power level diagram for the overall SIC requirements. The SIC overall requirement includes the minimum RF SIC requirement that is achieved in the RF domain so as to lower the transmit power received at the receiver front-end to a level avoiding the receiver saturation, also referred to the receiver desensitization threshold. In addition, the SIC overall requirement includes the complementary digital SIC requirement obtained in the digital domain for further lowering the transmit power experienced at the receiver front-end to the receiver noise floor.

A variety of self-interference cancellation techniques are known in the art to achieve a physically secured wireless link between two nodes or entities of the wireless communication network. FIG. 4 is a diagram illustrating the general categorization of self-interference cancellation (SIC) techniques according to where the cancellation of the self-interference signal takes place. Alongside the diagram, a receiving chain 200 is shown to illustrate at which location the self-interference is cancelled by the respective cancellation category. The receiving chain 200 includes in the RF domain 202 a receive antenna 204 and a low noise amplifier 206 to which the receive antenna 202 is coupled. A signal received at the receive antenna 204 and amplified by the low noise amplifier 206 is further processed in the analog domain 210. The analog domain 210 includes the local oscillator 212, the mixer 214, the low pass filter 216 and the analog-digital transducer 218. The signal received from the RF domain 202 is down-mixed, low pass filtered and converted into the digital domain 220 for further processing.

In FIG. 4, the categories, which have drawn much of attention in the recent published literature, are the digital domain cancellation and the RF domain cancellation. The analog domain cancellation performs SIC on the basis of the analog baseband signal, unlike the RF domain cancellation in accordance with which the SIC is performed on the basis of the up-converted signal in the analog RF domain 202. However, the analog domain cancellation, where the SI signal is cancelled in the analog domain 210 after the down-conversion 214 and before the ADC 218 (see reference [1]), does not offer any competitive advantages compared the to the RF domain cancellation.

Digital Self-Interference Cancellation

Many algorithms and signal models have been explored in the published literature for implementing the digital self-interference cancellation. Some approaches consider a linear model due to its simplicity. However, the linear model suppresses only the linear part of the residual self-interference signal in the digital domain, which is not sufficient in practical systems (see reference [16]). Other approaches are based on widely-linear models to increase the digital suppression amount (see reference [22]). Yet other approaches exploit even non-linear models to improve the performance of the residual self-interference suppression in the digital domain (see references [16], [23], [24], [25]).

RF Domain Cancellation

The RF domain cancellation techniques may be passive by attenuating the self-interference signal, referred to in the following as attenuation approaches, or active by adding a SIC signal to the RF reception signal, referred to in the following as signal-injection approaches.

Attenuation Approaches:

Attenuation based SIC approaches offer a first stage self-interference suppression method and accordingly reduce the interference requirement for any following cancellation stages. At the beginning of the full-duplex (FD) research, a SIC technique based on a specific placement of antennas was proposed (see references [2] and [3]). This cancellation technique needs two transmit antennas to be spaced apart from the receiver antenna by distances d and d+λ/2. In that way the two transmit antennas produce a null in their antenna pattern at the receiver antenna location. However, this cancellation technique works well only for narrowband systems, and around 30 dB of self-interference suppression at the center frequency is achieved. Other approaches attempt to overcome the just mentioned drawback, and reduce the number of the needed antennas (see references [4], [5], [6] and [7]). These approaches also make use of the directivity of the antennas in combination with other techniques such as the physical separation of the antennas, different polarizations and additional RF absorbing materials (see references [8], [9], and [11]).

The passive cancellation approach achieves the highest cancellation result in conditions where the transmit and receive antennas are oriented in two opposite directions, which may be suitable for relay station scenarios (see references and [13]), and more than 65 dB of suppression was measured over ˜165 MHz.

Further improvements are achieved by broadening the SIC bandwidth. In accordance with reference [14] an antenna structure is provided in which eight transmit monopole antennas are placed equidistantly in a ring shape, and the receive monopole antenna is mounted at an elevated position in the center of the ring structure. Unlike the above mentioned two-antennas-relative-distance approach, a progressive phase shift of 180° is applied to each opposite pair of transmit monopoles by means of an RF 180°-hybrid (analog beamformer circuitry). An overall self-interference suppression greater than 55 dB is achieved for this implementation, over a frequency band between 2.4 GHz and 2.5 GHz.

Another known element to connect one antenna with the transmit and receive chain is the 3-port RF-circulator, which is used to attenuate the Tx-to-Rx leakage (first-tap component of the self-interference radio channel) by benefiting from the anisotropic property of the RF-circulator (see reference [15]). The RF-circulator element may be used as a part of the entire self-interference mechanism, and may achieve 10 dB-15 dB of passive self-interference suppression (see references [16], [17] and [18]).

The above described passive techniques show high SIC results for the main (first tap) self-interference component, however, they are vulnerable against reflections and backscattering from the wireless channel, causing a frequency-selective behavior of the self-interference signal. A major drawback of the RF-circulator approach is the reflection at the antenna port due to impedance mismatch. In practical systems, the self-interference component may dominate the circulator leakage and hence limits the suppression performance to the reflection factor of the attached antenna.

Signal-Injection Approaches:

In the area of RF-injection techniques, reference [4] introduces an RF Balun (balanced-to-unbalanced transformer) to produce a negative version of the self-interference signal—as used historically for echo cancellation in telephones. This concept may be enhanced by including an active circuitry (QHx220 chip) for adapting the attenuation and the delay of the (negative) cancellation signal. For a bandwidth of 40 MHz, over 45 dB SIC was reached by means of the Balun setup, with a loss in the link-budget of around 6 dB. However, this approach has a serious practical limitation due to the additional nonlinearities that the active circuitry introduces into the SIC signal.

In contrast to the use of a Balun, references [5], [6] and [7] suggest using a 180°-hybrid transformer to generate the inverted version of the self-interference signal. By means of a digitally-controlled impedance-matching circuit the reflecting factor of the antenna is matched to suppress the self-interference through the RF-hybrid junction connectivity. However, this approach also compromises the link budget by 6 dB, similar to the balun based approach. Further, both approaches are limited to the cancellation of the main (first tap) self-interference component.

One of the most prominent approaches in the RF-injection category is the use of an auxiliary transmitter as is described in references [7], [11], [17], [18], [19], [20], [21]. This approach needs an additional or auxiliary transmission chain alongside the ordinary transmission chain. The additional chain is dedicated to replicate an inverted version of the self-interference signal and injects it at the receiver RF front-end to cancel the self-interference. Generating the SIC signal starts from I/O samples at the digital domain. This enables the implementation of several digital-signal-processing (DSP) algorithms in which the multipath self-interference wireless channel is included in the waveform of the SIC signal. Despite the flexibility that the active cancellation technique establishes by considering the whole self-interference wireless channel, this technique suffers from issues due to the hardware impairments that are usually encountered in typical wireless transceiver RF chains, such as the I/O imbalances (see references [18], [21] and [22]), the non-linear behavior of the components (see references [17], [23], [24] and [25]), and the local oscillator phase noise (see references [1], [26] and [27]). As a matter of fact, the non-deterministic nature of these impairments, for example, the phase noise, are the bottleneck in the active cancellation mechanism. For example the phase noise of the local oscillator limits the performance of the active cancellation mechanism (see references [1] and [26]), even though the same local oscillator is used for both transmit chains—the ordinary transmitter and the auxiliary transmitter. This is due to the fact that the self-interference signal travels through the ordinary transmission chain followed by a multipath radio channel, and accordingly is subjected to different delay values when compared to the SIC signal that only goes through the auxiliary transmission chain. The transmitter-generated noise is another limitation of this approach as it is generated independently at the ordinary and auxiliary transmitter chains (see reference [28]).

Another RF-injection technique focuses on the direct generation of a correlated cancellation signal in order to overcome the shortcomings of the auxiliary transmitter approach. This cancellation technique is based on a printed circuit board (PCB) with multiple routes having a different length in order to provide several delays. The multiple routes (taped delay lines) are supported with digitally-controlled adjustable attenuators. The entire design is used to imitate the circulator leakage and the antenna impedance-mismatch reflection (see references and [29]). However, the rest of the multipath self-interference wireless channel cannot be compensated by this setup. Another drawback of this approach is the off-coupling of the SIC signal, which may compromise a significant portion of the transmit power. This approach, in terms of canceling the self-interference, may reach a value of around 72 dB (see reference [16]) at the RF including the circulator suppression, however, it serves only to prove the concept. A real-world wireless transceiver which follows this approach has to deal with the implementation of the physical delay routes as progressive delay lines, which are extremely difficult to realize in practice. The extension of this approach to multiple antenna configurations complicates the RF structure (see reference [30]) even more.

Another approach suggests rearranging the delay routes on the PCB structure in a cluster shape, enabling complex channel coefficients to be applied to the SIC signal at the RF domain (see references [31], [32] and [33]). It has been stated that the clustered arrangement for the adjustable delay taps has advantages over the uniform arrangement (see reference [16]) by decreasing the dependency on the carrier frequency. However, the feasibility of the clustered structure in canceling the transmitter generated noise was not investigated.

Yet another approach adopts the same cancellation principle using an RF cancellation circuit which includes, in addition to the fixed delays taps, variable attenuators and phase shifters (see references [34] and [35]. The four-tap-delay structure achieves a minimum of dB of SIC over 30 MHz frequency band.

It is noted that the information in the above section is only for enhancing the understanding of the background of the invention and, therefore, it may contain information that does not form conventional technology that is already known to a person of ordinary skill in the art.

### SUMMARY

An embodiment relates to an apparatus for a wireless communication network, wherein the apparatus is to communicate with one or more entities in the wireless communication network using a plurality of different communication channels, the plurality of communication channels including at least a first communication channel and a second communication channel, wherein the apparatus is to transmit on one of the first and second communication channels and, at the same time, is to receive the other one of the first and second communication channels, and wherein, for exploiting a reciprocity of the first and second communication channels, the apparatus is to switch between simultaneously transmitting over the first communication channel and receiving over the second communication channel, and simultaneously transmitting over the second communication channel and receiving over the first communication channel.

According to another embodiment, a wireless communication system may have: one or more devices for communicating with one or more access points of a radio access network and/or with one or more further devices, wherein the one or more devices and/or the one or more access points and/or the one or more further devices include an inventive apparatus.

According to another embodiment, a method for operating an apparatus for a wireless communication network may have the steps of: communicating with one or more entities in the wireless communication network using a plurality of different communication channels, the plurality of communication channels including at least a first communication channel and a second communication channel, transmitting on one of the first and second communication channels and, at the same time, is to receive the other one of the first and second communication channels, and for exploiting a reciprocity of the first and second communication channels, switching between simultaneously transmitting over the first communication channel and receiving over the second communication channel, and simultaneously transmitting over the second communication channel and receiving over the first communication channel.

Another embodiment may have a non-transitory digital storage medium having a computer program stored thereon to perform the inventive method for operating an apparatus for a wireless communication network when said computer program is run by a computer.

### BRIEF DESCRIPTION OF THE DRAWINGS

Embodiments of the present invention will be detailed subsequently referring to the appended drawings, in which:

FIGS. 1(a)-1(b) show a schematic representation of an example of a wireless communication system;

FIGS. 2(a)-2(c) schematically illustrate the respective schemes, wherein

FIG. 2(a) illustrates the HD FDD scheme, FIG. 2(b) illustrates the HD TDD scheme, and FIG. 2(c) illustrates the FD scheme;

FIG. 3 schematically indicates a power level diagram for the overall SIC requirements;

FIG. 4 is a diagram illustrating the general categorization of self-interference cancellation techniques according to where the cancellation of the self-interference signal takes place;

FIGS. 5(a)-5(d) illustrate several single input single output, SISO, point-to-point scenarios using one or more communication channels between two nodes which are FD capable;

FIGS. 6(a)-6(c) illustrate a SISO point-to-multipoint scenario including multiple communication channels between an FD capable node and one or more HD TDD nodes;

FIG. 7 illustrates the concept of the propagation channel as an entity that is separate from any parts of the transmitter including the transmitter's antennas, and from any parts of the receiver including the receiver's antennas;

FIG. 8 illustrates the concept of a radio channel as an entity which includes at least the antennas used for the transmission and for the reception together with the propagation channel described in FIG. 7;

FIG. 9 schematically illustrates an apparatus operating in accordance with embodiments of the present invention and including two antennas;

FIG. 10 illustrates an example of an analog beamformer, ABF,

FIG. 11 illustrates an example of a digital beamformer, DBF,

FIG. 12 illustrates an example of a fully-connected hybrid analog-digital beamformer, HBF,

FIG. 13 illustrates an example of partly-connected hybrid analog-digital beamformer, HBF,

FIG. 14 illustrates signals and messages exchanged during a downlink, DL, beam management procedure for an initial access,

FIG. 15 illustrates signals and messages exchanged during an uplink, UL, beam management procedure for an initial access,

FIGS. 16(a)-16(c) illustrate an embodiment of the present invention, more specifically a device performing antenna switching in a single input single output, SISO FD transceiver,

FIG. 17 illustrates the operation concept on the time axis, more specifically a time-slot allocation using the antenna switching scheme in an FD SISO transceiver of FIG. 16,

FIGS. 18(a)-18(c) illustrate an embodiment of an antenna switching procedure for a FD SISO transceiver of FIG. 16 communicating with two communication partners,

FIGS. 19(a)-19(c) illustrates an embodiment of a reciprocal channel estimation procedure for a FD SISO transceiver of FIG. 16 communicating with two communication partners,

FIGS. 20(a)-20(b) illustrate SI interference signal path discrepancies in a switching matrix of an FD SISO transceiver of FIG. 16,

FIGS. 21(a)-21(b) illustrates embodiments of a backward compatibility of the inventive FD transceiver of the embodiment of FIG. 16,

FIG. 22 illustrates an embodiment of the FD transceiver of FIG. 16 having backward compatibility and a switching matrix including a circulator,

FIGS. 23(a)-23(b) illustrate an embodiment of the FD transceiver of FIG. 16 having a switch matrix and antennas with different polarizations,

FIG. 24 illustrates a further embodiment of the inventive FD transceiver allowing for a switching of communication channels defined in separate frequency bands for exploiting the reciprocity on the channels,

FIG. 25 illustrates a time slot allocation among a SISO FD equipment with an RF switching technique in accordance with the present invention and two TDD nodes,

FIG. 26 illustrates an embodiment the FD transceiver of FIG. 16 having a dual polarization antenna configuration,

FIG. 27 illustrates an embodiment of a 2×2 MIMO FD transceiver equipped with the inventive antenna switching technique,

FIGS. 28(a)-28(b) illustrate embodiments of a dual-polarization MIMO FD transceiver in accordance with embodiments of the present invention equipped with antenna pairs of different polarizations,

FIG. 29(a) to FIG. 31 illustrate embodiments of point-to-multipoint, P2MP, full duplex use cases combining a FD transceiver in accordance with embodiments of the present invention with heterogeneous HD and FD nodes, and

FIG. 32 illustrates an example of a computer system on which units or modules as well as the steps of the methods described in accordance with the inventive approach may execute.

### DETAILED DESCRIPTION OF THE INVENTION

Embodiments of the present invention is now be described in more detail with reference to the accompanying drawings in which the same or similar elements have the same reference signs assigned.

As has been described above, the self-interference cancellation may be considered a key enabling technique for a full-duplex wireless communication system. To achieve the desired frequency reuse in a full-duplex system, the self-interference needs to be reduced or cancelled, and among the SIC techniques described above, the antenna separation technique is a feasible technique to suppress the self-interference in the RF domain or in the analog domain by utilizing separate antennas, namely one antenna to transmit and another antenna to receive. Stated differently, dedicated transmit and receive transmit antennas are provided of which the transmit antenna is connected to the transmit font-end and the separate dedicated receive antenna is connected to the receive front-end thereby reducing a leakage of the transmit signal to the receive font-end, hence reducing the self-interference by means of a passive SIC technique. The antenna separation technique is advantageous as it is a passive technique and, therefore, does not use any power for the actual SIC purpose. Moreover, it allows suppressing all SIC components including noise, like transmitter-generated noise or local oscillator phase noise which, in general, are hard to cancel.

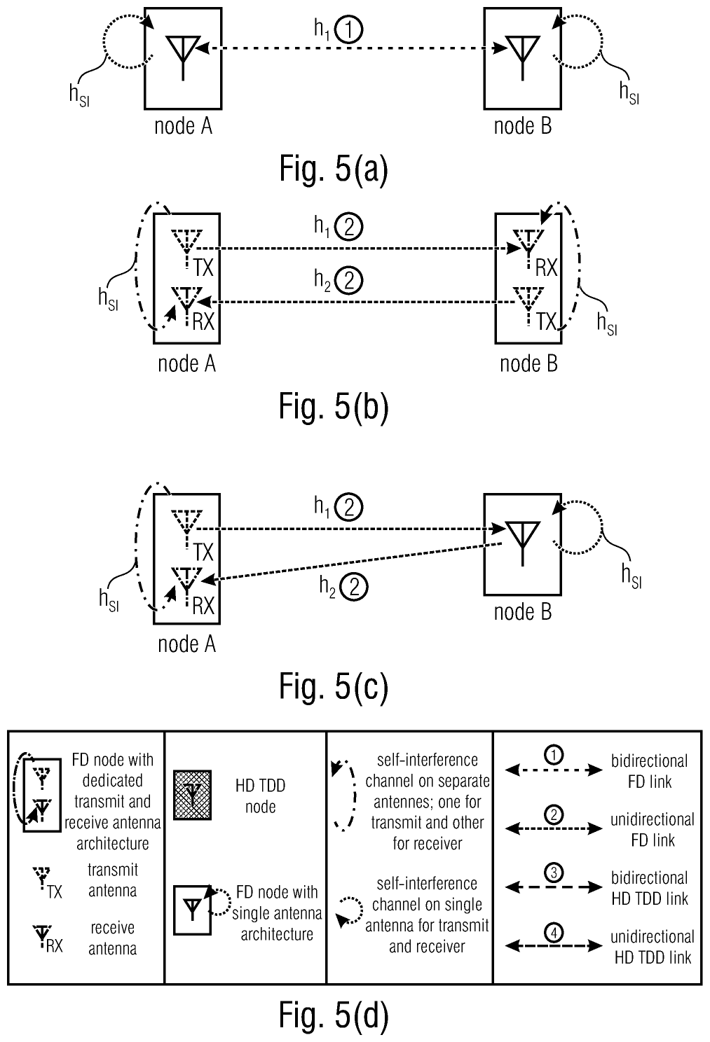

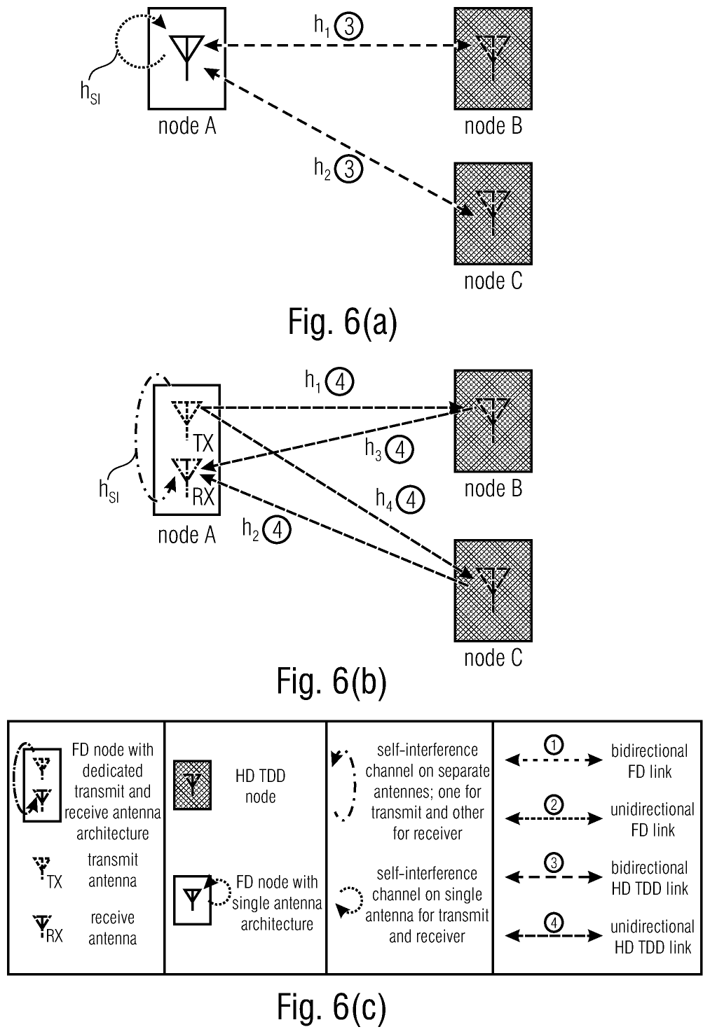

Despite this benefit of the antenna separation or isolation technique, it has a negative impact on the channel reciprocity among the transmit and receive channels. More specifically, once a transmitter and a receiver do not share the same antenna to transmit and to receive, the reciprocity among the transmit and receive communication channels is diminished. This occurs due to the fact that two communication channels are observed via two different antennas, the separate transmit and receive antennas. This impact of the antenna separation technique on the communication channels reciprocity is explained in more detail with reference to FIG. 5 and to FIG. 6. It is noted that channels are illustrated in the figures as line-of-sight links, however, there may also be multi-path or non-line-of-sight channels in practice.

FIG. 5 illustrates the one or more communication channels between two nodes which are FD capable in a single input single output, SISO, point-to-point scenario. In FIG. 5(a) the two FD nodes A and B both use a single antenna architecture so that when communicating with each other over the bidirectional FD link h₁ each of the nodes A and B experiences self-interference, as is indicated by the schematic representation of the self-interference channel h_{SI}. FIG. 5(b) illustrates an example in which the two FD nodes A and B both apply the antenna separation technique, i.e., both nodes employ dedicated transmit and receive antennas so that respective communication channels h₁ and h₂ are established between nodes A and B. In such a scenario, also the above-mentioned self-interference channels h_{SI} exist at the nodes A and B due to the coupling of a transmit signal at one node into the receive antenna of the same node. FIG. 5(c) illustrates a communication among two FD nodes, of which node A uses dedicated transmit and receive antennas while node B uses a single antenna. The communication is between the two antennas of node A and the single antenna of node B, thereby establishing the unidirectional FD links h₁ and h₂. Further, the self-interference channels h_{SI} are schematically illustrated at the respective nodes.

FIG. 6 illustrates a communication in a SISO point-to-multipoint scenario including the communication channels between an FD capable node A and two HD TDD nodes B, C. in FIG. 6(a) the FD node A includes a single antenna architecture and a communication with the HD TDD nodes B and C is over the bidirectional links or channels h₁ and h₂. The node A experiences a self-interference as is indicated by the self-interference channel h_{SI}. FIG. 6(b) shows a similar scenario as in FIG. 6(a) except that node A employs the antenna separation technique thereby establishing respective unidirectional links between the respective antennas of node A and the HD TDD nodes B and C, as illustrated by the communication channels h₁ to h₄. Again, the self-interference channel h_{SI} is schematically represented at the node A.

In a single antenna architecture, for example in scenarios as depicted in FIG. 5(a) and FIG. 6(a), in which one antenna is shared for transmitting and receiving, a bidirectional link is established, so that for a communication from node A to node B or from node B to node A the same wireless channel is experienced in both directions. On the other hand, when considering a scenario in which at least one of the nodes, for example node A, employs a dedicated antenna architecture using separate transmit and receive antennas, like node A in FIG. 5(b), FIGS. 5(b) and 5(c) and FIG. 6(b), the communication with node B or node C uses separate unidirectional links or different channels.

With regard to FIG. 5 and FIG. 6 it is noted, that the nodes employing dedicated antennas are illustrated as employing an antenna architecture having a single polarization for both antennas, however, in accordance with other examples the respective antennas in the node A for receiving and transmitting may be polarized differently. For example, node A using dedicated antennas for transmission and reception may also use a dual polarized antenna architecture.

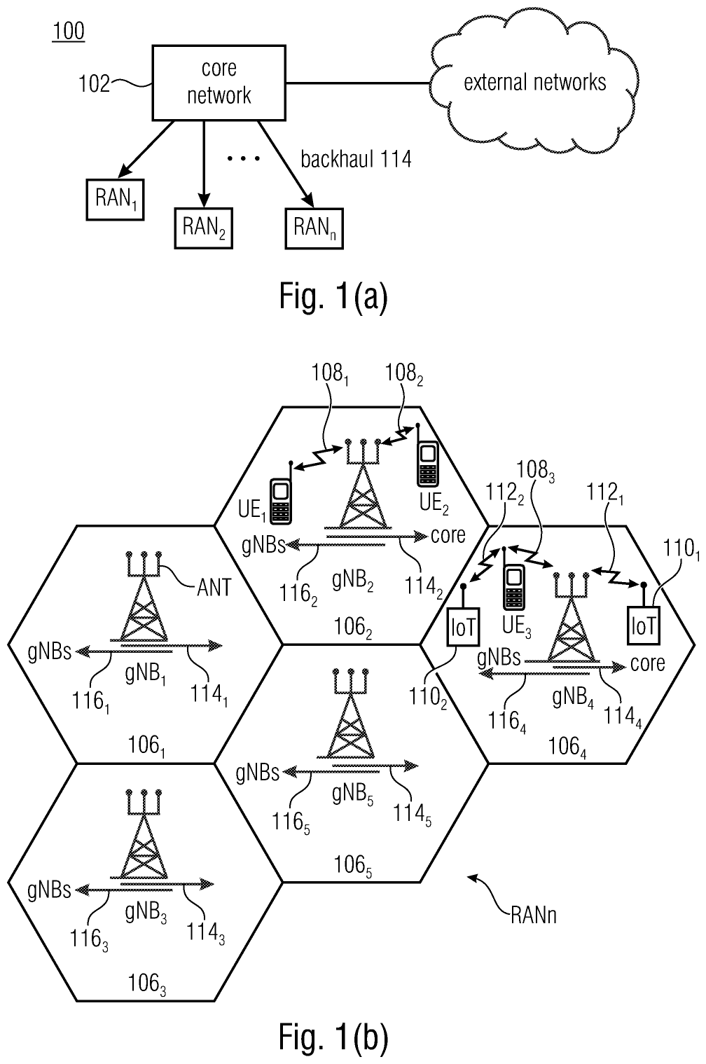

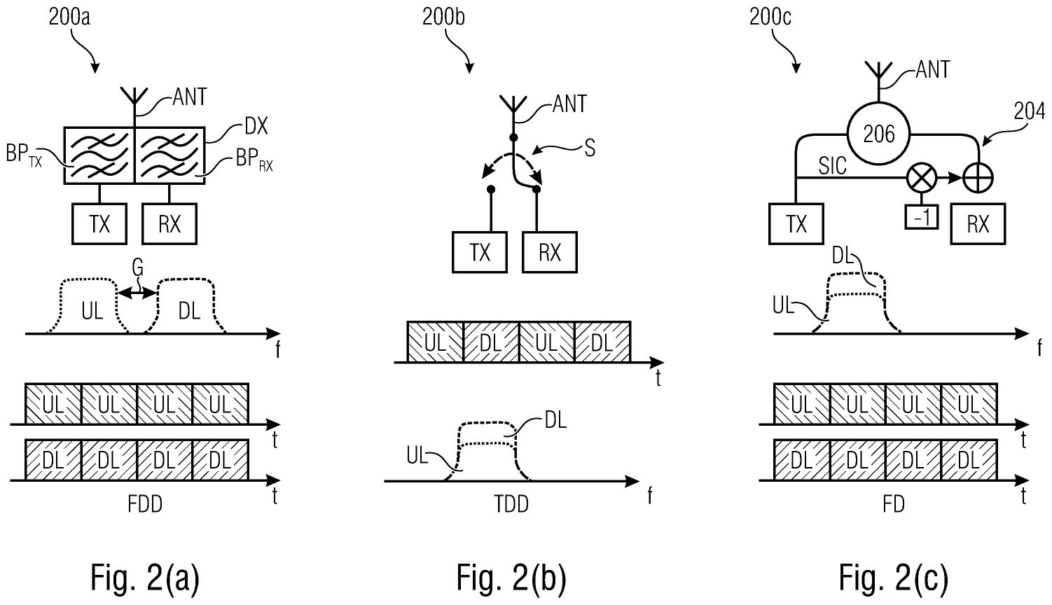

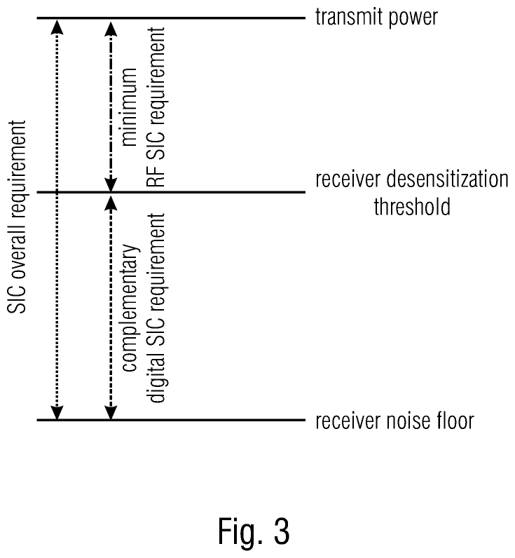

In wireless communication systems, like those described above, another property is the so-called channel reciprocity. For example, when considering a wireless communication network like the one described above with reference to FIG. 1, a base station, gNB, and a user equipment, UE, communicate with each other and an achievable date rate per communication link may be limited by the available bandwidth in any particular frequency band and if a frequency band is used exclusively for the uplink, UL, or for the downlink, DL. In conventional 2G, 3G and 4G networks, different wireless multiplexing schemes are allocated for different parts of the spectrum, thereby creating so-called FDD bands and TDD bands for particularly UL-DL channel allocations using the same spectrum band for the UL and for the DL, respectively. In accordance with TDD schemes, the associated mapping of the active UL and DL slots may follow a sequence as defined in a selected TDD frame structure. In TDD, the UL and the DL use the same part of the spectrum but switch between the UL and DL operations which needs to be synchronized between the communication nodes. On the other hand, in FDD schemes, respective FDD bands are used with one portion of the allocated spectrum in pure UL mode while the other part is used for DL only.

TDD allows an easy access to channel knowledge provided that the radio channel behaves reciprocally which is assumed when the channel is sufficiently stationary between the so-called channel estimation and the period when the transmission for which the channel was estimated is performed. This may be achieved by using identical antenna radiation patterns for the transmission and for the reception at either end of the link. The appropriate calibration between the antenna radiation patterns in the transmit mode and in the receive mode may be a step to be performed by the manufacturer of the node.

The above-described FD communication exploits the wireless channel in a more efficient manner by transmitting data, like payload data and control data, and/or reference signals while receiving or detecting data and/or reference signals at the same time. This is of interest for a better spectral efficiency when the UL and DL bands are identical, are partially overlapping, are adjacent or are in other ways similar, for example are defined by harmonics or frequency mixing products interfering with each other at the node.

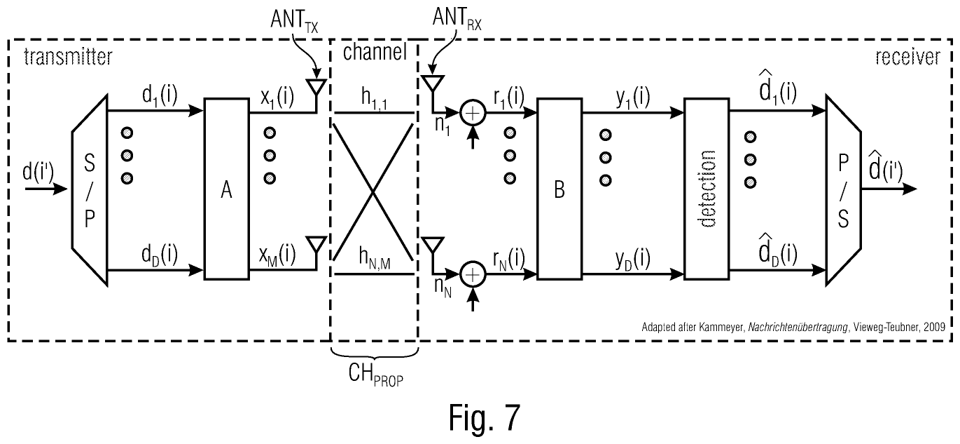

Due to the physics of wave propagation in space, the so-called propagation channel between two points A and B, for example, between the location of a base station and the location of a UE, has properties that are, in general, similar, e.g., in terms of the number of relevant multipath components, the power delay spectrum, the power angular distribution spectrum and the like. Further, these properties are basically frequency independent. FIG. 7 illustrates the concept of the so-called propagation channel as an entity that is separate from any parts of the transmitter including the transmitter's antennas, and from any parts of the receiver including the receiver's antennas. In other words, FIG. 7 illustrates an example of a wireless communication link in which the transmitter comprises the antennas ANT_{TX} used for transmission, the receiver includes the antennas ANT_{RX} for reception, and the channel CH_{PROP} is void of any hardware of the transmitter and the receiver, respectively and, therefore, is also referred to as the propagation channel. FIG. 7 further illustrates that the transmitter and the receiver may include multiple antennas. At the receiver side, the signal received over the propagation channel including the channel h_{1,1} to h_{N,M} includes noise n₁, nₙ (shown to be added to the receive signals r₁₍ᵢ₎ to r_{N (i)}). The received signals are forwarded from the antenna towards the RF circuit B, also referred to as RX RF chain or RX front-end. The signals processed by the RF circuit are applied to the detector for obtaining the respective symbols which are output by the receiver. The transmitter includes an RF circuit A for creating the signals to be transmitted via the antenna ANT_{TX}, the RF circuit also being referred to as the TX RF chain or TX front-end. The transmitter receives the data to be transmitted which is split into multiple symbols that are processed by the RF circuit for transmission over the antennas towards the receiver.

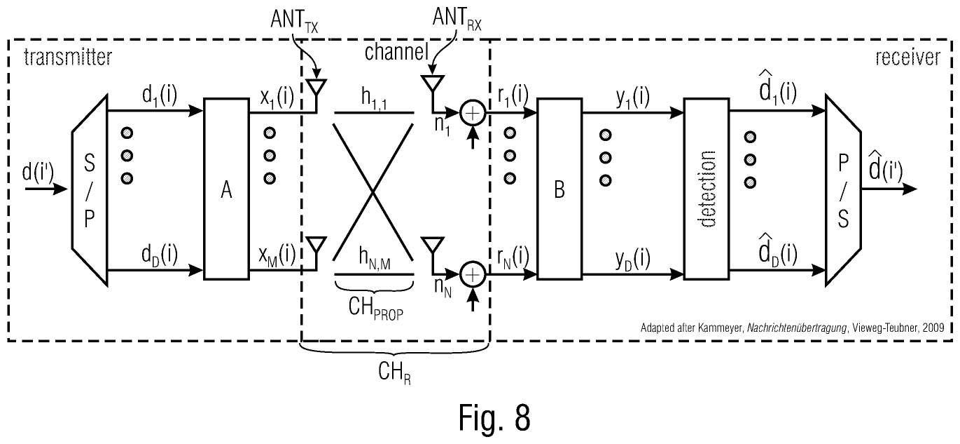

For the actual wireless communication between the transmitter and the receiver, the propagation channel CH_{PROP} is connected to the transmitter device and to the receiver device via the antennas ANT_{TX} and ANT_{RX} which have specific physical properties. In effect, the antennas, the RF front-ends, the communication architecture and the propagation channel combine to form an effective radio channel that involves the use of suitable and appropriate transmission and reception schemes. FIG. 8 illustrates the concept of the radio channel as an entity which includes at least the antennas used for the transmission and for the reception together with the propagation channel described above with reference to FIG. 7. More specifically, FIG. 8 illustrates a model of a wireless communication link in which the channel comprises both the propagation and antenna effects, i.e., incorporates besides the actual space between the transmitter and the receiver also the respective antennas, thereby forming what is called the radio channel CHR. Otherwise, the transmitter and the receiver correspond to what is described above with reference to FIG. 7.

The antenna design, like the design of beamforming antennas and electronically scanned antenna arrays, may depend on the link budget and the spherical coverage requirements of the nodes participating in the wireless link. The antenna design is frequency and band specific and the higher the frequencies the higher the path loss is between the transmit and receive antennas due to the fact that the effective aperture decreases as a function of frequency. The design of the antenna or antenna array follows engineering objectives including the link range or distance, the electronic scan angle for beam forming, the effective aperture to control sensitivity, like bandwidth, side lobe levels and null steering, and the like. As a result, the aggregation of wireless links in different frequency bands may experience significant differences with respect to the effect of the radio channel on multiple component carriers.

Thus, due to the fact that the radio channel comprises propagation and antenna effects, the radio channel between a transmitter and a receiver may vary over time. This makes it necessary to perform an estimation of the channel so as to adapt the transmit device and the receive device for correctly transmitting and receiving a signal transmitted over the channel. The radio channel may be considered to be not varying over a certain duration or time period, like the so-called coherence time, so that once a channel estimation has been performed, for the certain time, like the coherence time, the channel may be assumed to be reciprocal so that when receiving a signal over the channel which has been estimated, the same properties may be assumed for the channel when transmitting on the same channel.

The channel reciprocity is also a valuable and desirable property for a bi-directional full-duplex communication link as it allows, as mentioned, to use one channel estimation for both directions on the communication link. The reciprocity allows to estimate over one link direction and use estimation for the link in the opposite direction. In other words, it is not necessary to repeat the channel estimation for the communication in both directions and it may be done at either of the communication nodes. When considering the full duplex communication scheme described above with reference to FIG. 5 and FIG. 6, those schemes employing at both communication ends nodes with a single antenna architecture implement therebetween a common wireless channel for transmitting from node A to node B and from node B to node A. However, when considering the scenarios described above with reference to FIG. 5(b), FIG. 5(c) and FIG. 6(b), nodes employing dedicated transmit and receive antenna architectures establish separate wireless channels for a communication between the communication nodes, i.e., the wireless channels h₁ and h₂ in FIG. 5(b) and FIG. 5(c) as well as the channels h₁ to h₄ in FIG. 6(b) are actually different radio channels because different antennas are involved so that an estimate on one of the channels may not be used for a transmission or reception on another one of the channels. Stated differently, although the antenna-based cancellation technique is a useful technique when suppressing the self-interference, it usually effects the reciprocity of the incoming and outgoing communication channels.

Embodiments of the present invention provide approaches allowing for an effective suppression of self-interference in a FD communication node by using separate communication channels for a communication with one or more entities or nodes in a wireless communications systems. In accordance with embodiments, the separate communication channels are established between respective antennas of the FD communication node and antennas of the one or more entities. In accordance with such embodiments, the FD communication node employs for the SIC an antenna separation technique using separate antennas. In accordance with other embodiments, the separate communication channels are established by separate frequency bands of the spectrum employed for the communication between the FD communication node and the one or more entities, wherein the communication may employ one or more antennas at the FD communication node. In accordance with such embodiments, the FD communication node employs for the SIC a separation technique using the separate frequency band. In either case, the inventive approach employs the communication channel reciprocity. More specifically, in accordance with embodiments of the present invention, an apparatus for a full-duplex communication with one or more other entities of a wireless communication system is provided is operated in such a way that the apparatus switches between simultaneously transmitting over the first communication channel and receiving over the second communication channel, also referred to in the following as a first state or a first configuration, and simultaneously transmitting over the second communication channel and receiving over the first communication channel, also referred to in the following as a second state or a second configuration. Thus, the apparatus may switch the communication channels when communicating with one or more of the other entities in such a way that in a first state a first communication channel is a transmit channel and a second communication channel is a receive channel, while in a second state, for example, at a second time slot, the first communication channel is the receive channel and the second communication channel is the transmit channel.

In accordance with embodiments, at the respective times or states, respective estimates of the independent channels may be performed so that in the following communication the channel estimates may be used for the respective channels, thereby employing the channel communication's reciprocity in a similar way as in conventional approaches using only a single antenna and establishing a single bidirectional channel. For example, the one or more channel estimates for the first communication channel, which are obtained during operation of the first communication channel into one direction, are used for a transmission over the first communication channel into the opposite direction, and/or the one or more channel estimate for the second communication channel, which are obtained during operation of the second communication channel into one direction, are used for a transmission over the second communication channel into the opposite direction.

The channel estimates may be considered valid for a certain duration or time period following the estimation process. In accordance with embodiments, the channel estimates are valid within the coherence time. In accordance with further embodiments, their validity may be extended using extrapolation and prediction schemes and/or using channel estimates in different domains where the effective coherence time may be significant longer. In accordance with yet further embodiments, the mentioned duration or time period following the estimation process may include the coherence time and some additional time, e.g., an additional time during which still the gains obtained from the channel estimation are achievable, at least to a predefined extent. Thus, going beyond the coherence time does not erase all gains obtained from the channel estimation, so that the apparatus may still benefit from the initial channel estimation.

Thus, embodiments of the present invention provide for a bi-directional communication, where the channel into one direction is sufficiently reciprocal compared to the opposite direction so that the channel estimation into the forward direction can be used for transmit precoding into the reverse or opposite direction. When using the same channel simultaneously into both directions, the self-interference suppression is substantially less effective and therefore the system gain is limited. By using two sufficiently separated communication channels in parallel or simultaneously or at the same time, the problem is that the channel reciprocity is not given since the two channels are well isolated, e.g., they are not entangled and therefore different, so that the reciprocity is lost. By switching between the at least two channels for uplink and downlink operations, the simultaneous transmission and reception is enabled with the reciprocity maintained at the same time. Therefore, when compared to conventional approaches that may provide for transmitting and receiving at the same time, embodiments of the present invention add the switching so as to allow employing or so as to regain the reciprocity of transmit and receive channels.

In accordance with embodiments, a communication channel in accordance with the teachings described herein, may be the above-mentioned radio channel. It is noted that a communication channel is not limited to a single channel, rather a communication channel may also be formed of a group of channels, e.g., it may include an aggregation of radio channels or a plurality of multi-path propagation channels. For example, the communication channel may include one or more of the following:
a digital-analog-converter, DAC on the transmit side
an analog transmit chain,
a transmit antenna,
a wireless propagation channel,
a receive antenna,
an analog receive chain,
an analog-digital-converter, ADC, on the receive side.

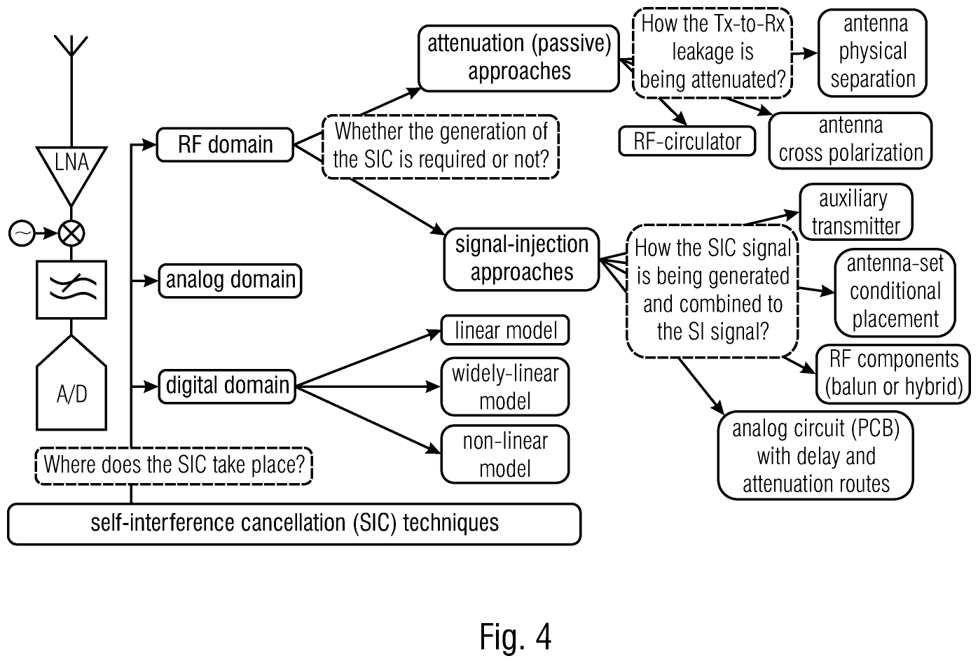

Although many SIC techniques are known, like the ones described above in detail with reference to FIG. 4, the reciprocity issue has not been considered in connection with SIC techniques using different or separate communication channel, either obtained by using the antenna separation based SIC technique or by using separate frequency bands for the communication, let alone resolved. Thus, there is no known solution that deals with the reciprocity complication due to the use of separate communication channel as they may be obtained by the antenna separation technique. This situation is solved by the various embodiments of the inventive approach which, effectively allows combining the advantages of the passive communication channel separation SIC techniques and the reciprocity of the wireless channels established between the FD apparatus and the one or more other communication nodes or entities within the communication system.

Apparatus

The present invention provides an apparatus for a wireless communication network, wherein the apparatus is to communicate with one or more entities in the wireless communication network using a plurality of different communication channels, the plurality of communication channels including at least a first communication channel and a second communication channel, wherein the apparatus is to transmit on one of the first and second communication channels and, at the same time, is to receive the other one of the first and second communication channels, and wherein, for exploiting a reciprocity of the first and second communication channels, the apparatus is to switch between
simultaneously transmitting over the first communication channel and receiving over the second communication channel, and
simultaneously transmitting over the second communication channel and receiving over the first communication channel.

In accordance with embodiments, for exploiting the reciprocity of the first and second communication channels, the apparatus is to repeatedly perform the switching, e.g., in accordance with one or more of the following:
predefined pattern,
a pattern defined based on channel properties,
a pattern defined based on network demands and restrictions
one or more operation modes, e.g., backward compatibility modes such as conventional TDD or shared-antenna FD.

In accordance with embodiments, for transmitting over the first and second communication channels, the apparatus is to use respective channel estimates for the first and second communication channels obtained when receiving over the first and second communication channels.

In accordance with embodiments, during a first time, the apparatus is to
transmit over the first communication channel and receive over the second communication channel simultaneously, and
estimate one or more channel properties of the second communication channel, during a second time, the apparatus is to
transmit over the second communication channel and receive over the first communication channel simultaneously, and
estimate one or more channel properties of the first communication channel, and

at further times following the second time, the apparatus is to
transmit over the first communication channel using the one or more channel properties estimated for the first communication channel, and/or
transmit over the second communication channel using the one or more channel properties estimated for the second communication channel.

In accordance with embodiments, the apparatus is to use the one or more channel estimates for the first communication channel during a certain time period, e.g., a coherence time of the first communication channel, and/or the one or more channel estimates for the second communication channel during a certain time period, e.g. a coherence time of the second communication channel.

In accordance with embodiments, the apparatus is to use the one or more channel estimates for the first communication channel obtained during operation of the first communication channel into one direction for transmission over the first communication channel into the opposite direction within a certain time period, e.g., a coherence time of the first communication channel, and/or the one or more channel estimates for the second communication channel obtained during operation of the second communication channel into one direction for transmission over the second communication channel into the opposite direction within a certain time period, e.g., a coherence time of the second communication channel.

In accordance with embodiments, the apparatus comprises one or more antennas and is to simultaneously transmit and receive on a plurality of different frequency bands, the plurality of different frequency bands comprising at least a first frequency band and a second frequency band, wherein, for simultaneously transmitting over the first communication channel and receiving over the second communication channel, the first communication channel comprises a first frequency band and the second communication channel comprises a second frequency band, and wherein, for simultaneously transmitting over the second communication channel and receiving over the first communication channel, the first communication channel comprises the second frequency band and the second communication channel comprises the first frequency band.

In accordance with embodiments, the apparatus comprises a plurality of antennas, wherein, for simultaneously transmitting over the first communication channel and receiving over the second communication channel, the first communication channel comprises one of the plurality of antennas and the second communication channel comprises another one of the plurality of antennas, and wherein, for simultaneously transmitting over the second communication channel and receiving over the first communication channel, the first communication channel comprises the other one of the plurality of antennas and the second communication channel comprises the one of the plurality of antennas.

In accordance with embodiments, the plurality of antennas comprises one or more of the following:
different antennas,
different subsets of antenna elements, or
different combinations of antenna elements.

In accordance with embodiments, the first and second antennas comprise one or more of the following:
mutually polarized antennas,
mutually polarized antenna panels, each antenna panel comprising one or more antenna elements,
one or more mutually polarized antenna elements of a common antenna panel,
physically separate antenna panels, each antenna panel comprising one or more antenna elements,
one or more antenna elements of a common antenna panel.

In accordance with embodiments, for estimating the first and second communication channels, the apparatus is to perform one or more of the following:
measure one or more reference signals received from the one or more entities over the first and second communication channels and estimate the first and second communication channel using the measurement of the reference signals,
transmit one or more reference signals over the first and second communication channels to the one or more entities, e.g., to allow the one or more entities to obtain channel state information and return it to the apparatus,
transmit one or more reference signals over the first and second communication channels, receive from the one or more entities estimates for the first and second communication channel obtained by the one or more entities using a measurement of the reference signals transmitted by the apparatus, and estimate the first and second communication channel using the estimates received from the one or more entities.

In accordance with embodiments, the apparatus is to use the estimates for a beamforming procedure on the first and second communication channels, like beam management, beam correspondence, and/or precoding.

In accordance with embodiments, in case the apparatus is not capable to obtain the estimates or in case the estimates are judged to be not reliable, the apparatus is to request from the one or more entities assistance information for the beamforming procedure, or responsive to request from the one or more entities, the apparatus is to provide to the one or more entities assistance information for the beamforming procedure.

In accordance with embodiments, the apparatus comprises a plurality of beamforming units, the plurality of beamforming units including at least a first beamforming unit associated with the first communication channel and a second beamforming unit associated with the second communication channel, in case the apparatus is not capable to obtain the estimates for one of the first and second communication channels or in case the estimates for one of the first and second communication channels are judged to be not reliable, the apparatus is to request form the one or more entities assistance information for the beamforming procedure to be used by the beamforming unit associated with the one communication channel.

In accordance with embodiments, the assistance information for the beamforming procedure indicates or signals one or more of the following:
the transmit and/or receive antenna ports associated with the first and second communication channels,
the beam for one of the communication channels and/or the beam pair for both communication channels being swept by a beam management procedure,
the measurements of the beam for one of the communication channels and/or the beam pair for both communication channels,
the transmit and/or receive beam for one of the communication channels and/or the beam pair for both communication channels determined by a beam correspondence procedure,
the precoder selected by the apparatus and/or a decoder to be selected at the one or more entities,
information for coordinating the precoder at the apparatus and the decoder at the one or more entities.

In accordance with embodiments, the assistance information is signaled using one or more configured or preconfigured messages, like Signaling Extensions Flexible Antenna Port Mapping, S4FAPM, signaling messages.

In accordance with embodiments, the one or more configured or preconfigured messages include one or more configuration messages signaling one or more of the following:
how antenna port configurations and associated antenna patterns are be reported,
what assistance information is to be reported,
a format of the one or more configured or preconfigured messages.

In accordance with embodiments, the one or more configured or preconfigured messages include one or more capability messages signaling one or more of the following:
current capabilities of the apparatus and/or the one or more entities,
current settings of the apparatus and/or the one or more entities, and
acknowledgements of configuration commands.

In accordance with embodiments, the capabilities of the apparatus and/or the one or more entities comprise one or more of the following:
capability information for supporting use of the one or more configured or preconfigured messages, like information regarding parameters of observation capabilities and associated parameterization, metrics and measurement uncertainties,
information about a message space configuration supported by the apparatus and/or the one or more entities,
information about features and assistance modes supported by the apparatus and/or the one or more entities, like one or more of the following antenna port properties and/or configurations:
   an inter-band distance,
   a system bandwidth per band, like the available bandwidth over all component carriers used for UL and/or DL,
   a number of antenna elements, a spacing and geometric distribution of the antenna elements,
   an effective aperture and an effective beamwidth,
   beam steering angles and ranges,
   an effective temporal and angular resolution,
   an antenna array orientation, direction, directivity, spatial pattern overlaps for each antenna port,
   a number of antenna port configuration states used by the apparatus,
   one or more patterns of switching between antenna port configuration states, like antenna port mapping configurations,
   an uplink/downlink relation between antenna port configuration states,
   a transmission/reception relation between antenna port configuration states,
      wherein the relation refers to the same and/or different antenna port configuration states, and/or
      wherein the relation refers to a mapping to particular radio resources, e.g.,
         in the spectrum domain: carriers, like for FDD, TDD, one or more bandwidth parts, BWP, one or more bands, like licensed, unlicensed, and/or band combinations,
         in the time domain: one or more radio frame, one or more slots, one or more OFDM symbols, etc.
         in the spatial domain: one or more spatial beams, one or more antenna radiation patterns, one or more polarizations, direction of arrival, DoA, direction of departure, DoD,
         antenna elements: center of radiation reference point, one or more sub-arrays, a proximity of antenna elements, a cross-coupling between antenna ports,
         a similarity and/or a dissimilarity of the communication channels and/or components contributing to the communication channels: allowing one of the communication channels to predict changes in another one of the communication channels in case the similarity meets an associated threshold and/or the dissimilarity meets an associated threshold.

In accordance with embodiments, the one or more configured or preconfigured messages include one or more command messages signaling one or more commands to be executed or recommended to be executed by the apparatus and/or the one or more entities.

In accordance with embodiments, the apparatus comprises at least one RF transmitter chain; at least one RF receiver chain, an RF circuit and an antenna unit for transmitting and receiving radio signals; and a switching circuit connected between the RF transmitter chain and the RF circuit and between the RF receiver chain and the RF circuit, wherein the switching circuit is to selectively connect
for simultaneously transmitting over the first communication channel and receiving over the second communication channel, the RF transmitter chain to a first connection or terminal of the RF circuit, and the RF receiver chain to a second connection or terminal of the RF circuit, and
for simultaneously transmitting over the second communication channel and receiving over the first communication channel, the RF transmitter chain to the second connection or terminal of the RF circuit, and the RF receiver chain to the first connection or terminal of the RF circuit.

In accordance with embodiments, the RF circuit comprises one or more antennas; and a plurality of filters, the plurality of filters including at least a first filter defining the first frequency band and a second filter defining the second frequency band, wherein the switching circuit is to selectively connect
for simultaneously transmitting over the first communication channel and receiving over the second communication channel, the RF transmitter chain to the first filter of the RF circuit, and the RF receiver chain to the second filter of the RF circuit, and
for simultaneously transmitting over the second communication channel and receiving over the first communication channel, the RF transmitter chain to the second filter of the RF circuit, and the RF receiver chain to the first filter of the RF circuit, or
for simultaneously transmitting over the first communication channel and receiving over the second communication channel, the RF transmitter chain to a first filter terminal of a frequency duplexing filter, and the RF receiver chain to a second filter terminal of the frequency duplexing filter, and
for simultaneously transmitting over the second communication channel and receiving over the first communication channel, the RF transmitter chain to the second filter terminal of the frequency duplexing filter, and the RF receiver chain to the first filter terminal of the frequency duplexing filter.

In accordance with embodiments, the transceiver circuit comprises a plurality of antennas, the plurality of antennas comprising at least a first antenna and a second antenna; wherein the switching circuit is to selectively connect
for simultaneously transmitting over the first communication channel and receiving over the second communication channel, the RF transmitter chain to the first antenna of the RF circuit, and the RF receiver chain to the second antenna of the RF circuit, and
for simultaneously transmitting over the second communication channel and receiving over the first communication channel, the RF transmitter chain to the second antenna of the RF circuit, and the RF receiver chain to the first antenna of the RF circuit.

In accordance with embodiments, the switching circuit comprises a plurality of inputs, the plurality of inputs including at least a first input connected to the RF transmitter chain and a second input connected to the RF receiver chain; a plurality of outputs, the plurality of outputs including at least a first out connected to the first connection of the RF circuit and a second output connected to the second connection of the RF circuit; and a plurality of switching elements to selectively connect the plurality of inputs and the plurality of outputs.

In accordance with embodiments, the switching circuit is to connect
for simultaneously transmitting over the first communication channel and receiving over the second communication channel, the first input to the first output and the second input to the second output, and
for simultaneously transmitting over the second communication channel and receiving over the first communication channel, the first input to the second output and the second input to the first output.

In accordance with embodiments, when the apparatus does not operate in simultaneously transmitting and receiving mode, the switching circuit is to
provide no connection to the second connection of the RF circuit, and, for simultaneously transmitting over the first communication channel and receiving over the second communication channel, connect the RF transmitter chain to the first connection of the RF circuit, and, for simultaneously transmitting over the second communication channel and receiving over the first communication channel, connect the RF receiver chain to the first connection of the transceiver circuit, or
connect the RF transmitter chain to the first connection of the RF circuit, and the RF receiver chain to the second connection of the RF circuit, wherein, for simultaneously transmitting over the first communication channel and receiving over the second communication channel, the apparatus is to transmit, and for simultaneously transmitting over the second communication channel and receiving over the first communication channel, the apparatus is to receive.

In accordance with embodiments, the switching circuit comprises a passive, non-reciprocal device connected between one of the first and second connections of the RF circuit and the RF transmitter chain, wherein, to provide backward compatibility to a shared-transmit-and-receive antenna in FD mode, the switching circuit is to connect the RF transmitter chain via the passive, non-reciprocal device to the first connection of the transceiver circuit, and the RF receiver chain to the passive, non-reciprocal device.

In accordance with embodiments, the apparatus is configured to
estimate a link quality of a communication link with the one or more entities when simultaneously transmitting over the first communication channel and receiving over the second communication channel and when simultaneously transmitting over the second communication channel and receiving over the first communication channel, and
select for a communication with the one or more entities, a simultaneous transmission over the first communication channel and reception over the second communication channel or a simultaneous transmission over the second communication channel and reception over the first communication channel dependent which configuration yielded the higher link quality.

In accordance with embodiments, the apparatus and/or the one or more entities comprise one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a base station, e.g. a macro or small cell base station, or a central unit of a base station, or a distributed unit of a base station, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a transceiver, or any sidelink capable network entity.

In accordance with embodiments, one or more of the entities comprise a full-duplex node having a single shared transmit and receive antenna or dedicated transmit and receive antennas, the apparatus is to receive a full-duplex node an indication whether the a full-duplex node comprises an inventive apparatus,
responsive to an indication that the a full-duplex node comprises an inventive apparatus, the apparatus, for simultaneously transmitting and receiving to/from the a full-duplex node, is to perform the switching,
responsive to an indication that the a full-duplex node comprises no inventive apparatus, the apparatus, for simultaneously transmitting and receiving to/from the full-duplex node, is to simultaneously transmit over the first communication channel and receive over the second communication channel and/or simultaneously transmit over the second communication channel and receive over the first communication channel.

System

The present invention provides a wireless communication system, comprising one or more devices for communicating with one or more access points of a radio access network and/or with one or more further devices, wherein the one or more devices and/or the one or more access points and/or the one or more further devices comprise an inventive apparatus.

In accordance with embodiments, the one or more further devices comprise one of more of the following:
a half-duplex TDD or FDD node,
a full-duplex node having one or more dedicated receive and transmit antennas, like a TDD node
a full-duplex node having one or more antennas, like a FDD node.

Method

The present invention provides a method for operating an apparatus for a wireless communication network, the method comprising: communicating with one or more entities in the wireless communication network using a plurality of different communication channels, the plurality of communication channels including at least a first communication channel and a second communication channel, transmitting on one of the first and second communication channels and, at the same time, is to receive the other one of the first and second communication channels, and for exploiting a reciprocity of the first and second communication channels, switching between
simultaneously transmitting over the first communication channel and receiving over the second communication channel, and
simultaneously transmitting over the second communication channel and receiving over the first communication channel.

Computer Program Product

Embodiments of the present invention provide a computer program product comprising instructions which, when the program is executed by a computer, causes the computer to carry out one or more methods in accordance with the present invention.

Embodiments of the present invention address the above identified deficiency in conventional approaches, like in conventional LTE or NR communication networks, when a UE or another network entity, is communicating with the network or with another network entity or another UE using a wireless bidirectional link between the antenna ports of the two ends of the wireless communication link wherein the antenna ports may be used for reception and transmission, either at the same time or in subsequent time instances. When transmitting/receiving a matching to the actual radio channel is needed and an accurate matching is needed to achieve a desired link performance, for example, in terms of throughput, bit error rate, BER, block error rate, BLER. In addition, transmit and receive precoding may be employed, for example, for selecting suitable transmit/receive antenna patterns through beam management procedures. Antenna ports are logical representations of antenna arrangements formed of one or more antennas or combinations thereof, which may be used to connect the device to the wireless propagation channel, thereby forming the radio channel as explained above with reference to FIG. 7 and FIG. 8, for example, by creating an appropriate antenna radiation pattern or beam pattern on a selected antenna port. The wireless propagation channel is reciprocal by nature, so that, in accordance with embodiments of the present invention, the bidirectional communication link exploits this property by using the same antenna radiation pattern for transmission and reception at either end of the wireless link, and, furthermore, by using the same combination of antenna port mappings for the selected bidirectional link configuration.

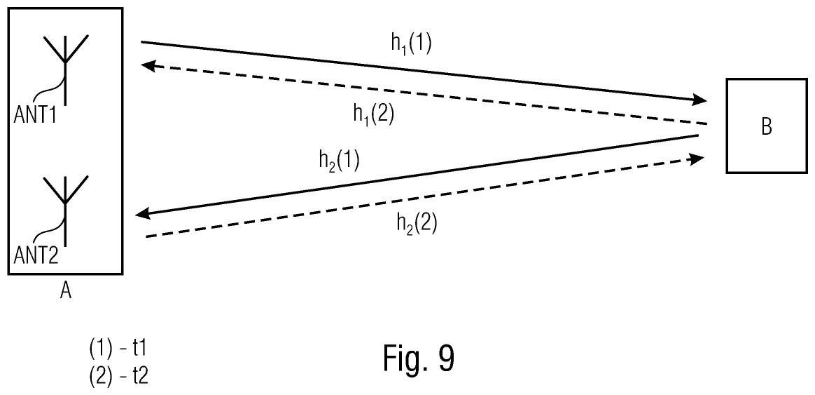

FIG. 9 schematically illustrates an embodiment of the inventive concept. FIG. 9 illustrates an apparatus A operating in accordance with embodiments of the present invention and including two antennas ANT1 and ANT2. The apparatus is also referred to as a communication node or simply as a node A and communicates with one or more further entities in the network, like a further node B. For the communication between node A and node B, respective radio channels h₁ and h₂ are formed between the first antenna ANT1 and an antenna of node B and between the second antenna ANT2 and node B. At a first instance or at a first time t1, node A transmits to node B using antenna ANT1 over the channel h₁ that is directed towards the node B while it receives over channel h₂ a transmission from node B at antenna ANT2. Thus, the node A simultaneously receives and transmits on the two channels h₁ and h₂. At a second time t2 or at a second instance, the node A transmits to node B using the channel h₂ between antenna ANT2 and a node B while node A receives from node B via antenna ANT1 over channel h₁. For example, it is considered that node A and node B may use a certain setting that creates a certain antenna radiation pattern. Node A may select a setting A for transmitting at the first time to node B which may employ a setting B. At the second time instance the node A may use the setting B known to be used at node B for transmitting while node B which is aware of setting A uses this setting for receiving from the node A. Stated differently, when considering FIG. 9, it is assumed that node B uses the same antenna radio patterns for the transmission and for the reception, respectively. The switching of the transmit/receive channels explained above with reference to FIG. 9 at the different instances of time provides an UL-DL combination allowing to exploit the reciprocal nature of the radio channels. More specifically, channel knowledge on each channel may be obtained for a transmission in one direction at the node A, for example, so that, in the example of FIG. 9, node A may estimate the channel h₂ at the time t1 or first instance while the channel h₁ may be estimated at the next time t2 or next instance when the node A receives from the node B via the channel h₁. Thus, for both channels h₁ and h₂ channel estimates exist or are available after once switching the antennas between transit and receive mode at the node A so that for the further communication between node A and node B the channel estimates, now known for both channels, may be employed, for example, by applying the knowledge for a radio channel adaptive transmit precoding on the channels.

In accordance with embodiments, the estimates may be used during the above-mentioned certain duration or time period, like the coherence time of the channels, so that any communication falling within this time does not require switching of the antennas. In case it is determined that the channel properties vary, for example certain parameters show a variation going beyond a predefined threshold or when a coherence time lapsed, the above switching described with reference to FIG. 9 may be repeated to obtain new channel estimates for the radio channels h₁ and h₂.

In accordance with embodiments the antennas described with reference to FIG. 9 may comprise one or more of the following:
different antennas,
different subsets of antenna elements, or
different combinations of antenna elements.

The different antennas or elements may be formed by one or more of:
disjoint or separate elements,
partially disjoint elements,
one or more common elements that are operated such that an effective part of the element contributing to a radio channel is different, e.g., a patch antenna with two excitation ports and a so-called Brennscheiden-coupler behind, where depending which port use one may create two different, e.g., orthogonal, circular polarization modes. In such a scenario exactly the same antenna elements are used as the first and second antennas but the two modes are well isolated and, thereby may be used in accordance with embodiments of the present invention.

Thus, the inventive approach is advantageous as it enhances the operation of devices in a full duplex mode using channel separation techniques for obtaining a passive SIC while exploiting the radio channel reciprocity even though a particular node may not be capable to operate the same antenna port setting for a transmission and for a reception in exactly the same slot or configuration simultaneously. Stated different, in accordance with embodiments of the present invention, the channel reciprocity effect may be employed also for communication links which are comprised of multiple antennas or antenna ports which may be used at each end of a link for a transmission and a reception, and providing reciprocal antenna radio patterns so that, in case any internal self-interference suppression is not sufficient, the channel or antenna separation technique for the self-interference cancellation may be employed which exploits the isolation between the selected channels or antenna arrangements for the simultaneous transmit and receive operations while the antenna radiation pattern of the simultaneously activated antenna arrangements are chosen to be different and, therefore, resulting in different radio channels.

This means that when using different antenna arrangements and associated antenna ports for a simultaneous reception and transmission at a particular point in time are non-reciprocal with regard to the respective antenna radiation patterns, however, in combination with the switched or swapped antenna port mapping as described above with reference to FIG. 9, in accordance with the inventive approach, at least two reciprocal transmit and receive pairs may be created that allow for exploiting the channel reciprocity and may be used, for example, for a radio channel matched transmit precoding when the channel remains sufficiently stationary between the channel estimation and the application of the transmit channel precoder, for example, in a subsequent time slot. In other words, switching between the antenna arrangement, also referred to as antenna port mapping, allows for exploiting the radio channel reciprocity which, in accordance with embodiments, allows for an enhanced transmit beamforming or precoding while operating the device in a full duplex mode with a well isolated channel or antenna arrangement for the simultaneous transmission and reception.

Thus, in accordance with embodiments, the same pair of antenna radiation patterns may be used by a node for the uplink transmission and for the downlink reception at time instances when the radio channel is considered to behave reciprocal. This allows to obtain channel knowledge from the uplink to be used for precoding in the downlink channel and vice versa. For example, the channel may be considered to behave reciprocal during the so-called channel coherence time which is a function of the mobility of the communication nodes relative to the surrounding propagation environment, the used carrier frequency, the antenna radiation pattern, the applied waveform, like OFDM, OTFS, etc., and the like. By selecting appropriate combinations of these parameters dependent on the respective scenarios, embodiments of the present invention allow to benefit from the reciprocity assumption when operating an apparatus in a full duplex scheme in combination with alternating antenna pair mappings employing the antenna separation technique.

The inventive approach as described above with reference to FIG. 9 may be employed in a scenario in which the other entity, like node B, may an HD node. In accordance with other scenarios, node B may be a FD node so as to allow a FD radio operation on the uplink and downlink between nodes A and B. In any case, in such an FD communication scenario implementing the inventive approach allows reducing the experienced self-interference to a tolerable threshold by applying the channel or antenna separation technique while exploiting the channel reciprocity benefits without the need to implement any further measures because the tolerable threshold for the experienced self-interference is achieved by the channel or antenna separation technique.

The present invention is advantageous over conventional approaches. More specifically, embodiments of the present invention provide advantages over conventional solutions, like the capability to obtain and exploit channel estimation even in a FD scenario employing separate channels or antennas for transmission and reception by exploiting the channel estimation from one wireless link direction to be used for an improved signal detection or optimization of the wireless link in the opposite direction.

Embodiments of the present invention relate to the signaling of the inventive antenna switching or flexible antenna port mapping also referred to as the signaling for flexible antenna port mapping, S4FAPM. This signaling may include one or more of the following processes:
An acquisition of reciprocal wireless links on an effective radio channel between two or more nodes, including:
   an acquisition of main beam directions, e.g., during an initial beam pairing,
   a refinement of the beam-pairing, e.g., an—optimization of the beamforming,
   a tracking of the paired beams under channel dynamics to maintain the reciprocity.
An identification and tracking of alternative beam/antenna port pairing options between the wireless communication nodes and/or alternative or suitable selections of transmit and receive antenna ports of at least one of the nodes when operating in simultaneous transmit and receive mode of operation.

The actual signaling performed by the UE and the network node may be enhanced by or may benefit from:
A faster acquisition of beam directions and/or beam pairing.
A higher accuracy or a reduced measurement uncertainty for the identification of an optimum selection and tracking of dominant multipath components, MPCs, and the associated beamforming.
A more robust beam selection and combination of the antenna ports for link pairs/beam pairs when considering the simultaneous operation of transmission and reception for a more spectrally efficient use of the bi-directional wireless data pipe.
An enhanced interference reduction by more educated beamforming.
An enhanced self-interference reduction by choosing well isolated antenna ports for the transmission and the reception.
An assistance due to UL-DL (inter-direction related) information exchange when allocating precoders and self-interference cancellation settings.
An improvement of certain metrics, such as the Signal to Noise Ratio, SNR, the Signal to Interference and Noise Ratio, SINR, the Carrier to Noise Ratio, CNR, the Carrier to Interference Noise Ratio, CINR, and the like.
An improvement of the spectral efficiency, the channel use, the spatial reuse.
An improvement of the positioning accuracy (geolocation).
Improvements due to the flexible use of band combinations for Mobile Operators and nodes connected to different parts of the spectrum using the same or different radio access technologies.
Improvements for Listen-Before-Talk, LBT, methods used, e.g., in the Industrial Science and Medical, ISM, bands for WiFi, New Radio Unlicensed, NR-U, Long Term Evolution-Unlicensed, LTE-U, and the like.
Improvements for satellite and deep space communication, where polarization multiplexing may be exploited.
Improvements for polarization multiplexing schemes in multiband combinations for the opposing wireless link directions and/or for a band aggregation into one direction, e.g., if only one or a few relevant multi-path components, MPCs, are used for the bi-directional wireless communication between the two or more nodes.

Embodiments of the present invention provide a bidirectional communication system or method connecting communication nodes at two locations, like location A and location B, as schematically illustrated in FIG. 9, by exchanging data using a wireless propagation channel and an effective radio channel as described above with reference to FIG. 7 and FIG. 8. The wireless links in the uplink and downlink directions are provided, and the associated pairs of antennas or antenna radiation patterns are selected or switched in such a way that a reciprocal behavior of the effective radio channel is experienced, while one or both nodes operate their antenna ports simultaneously for the uplink and downlink operations. The antenna ports for the transmission and reception may be different or may be the same with respect to the radiation pattern for the transmission and/or the reception node.

In accordance with embodiments, the uplink and the downlink may be operated:
in paired bands in the spectrum which are separated to suppress crosstalk by a frequency duplex filter, like in FDD,
in the same frequency band, like in TDD, or in partially overlapping frequency bands in a TDD mode,
in adjacent bands employing flexible TDD or TDD in a FDD duplex gap,
in bands nearby in the spectrum, like a TDD with insufficient gap,
in otherwise interference coupled bands, like bands coupled by harmonics, frequency mixing products or other transmitter-receiver crosstalk.

The inventive approach provides a system and entities of the system which allow to benefit from the reciprocity in the radio channel between the paired uplink and downlink slots used at the same time or at different times.

In accordance with embodiments, a receiver at a node performs radio channel measurements, like a channel estimation, in one wireless link direction and uses this measurement for a transmission in the opposite wireless link direction, for example, for the beam management or transmit precoding, like beam correspondence or radio channel adaptive precoding. The measurement or estimation may also be used for beam management of the transmit beam of the corresponding transmitting node for the same wireless link direction. Embodiments allow for a configuration between the active antenna ports to be used for the two directions of the communication, like the uplink and downlink directions to be chosen in such a way that reciprocity may be exploited for the link and/or for a simultaneous transmission and reception of one or both nodes with a sufficient suppression of self-interference when operating simultaneously.

In accordance with embodiments, the antenna port pairing between a transmitter and a receiver at a node and the sequential or alternating operation of the configurations allows for utilizing the reciprocity of the radio channel while using different antennal arrangements or antenna ports for transmissions and receptions, for example, in the same frequency band, or using the same antenna arrangements for transmissions and receptions in different frequency bands, FDD.

The reciprocity of the bidirectional radio channel may be based on a measurement or observation at one end of the link using a particular antenna arrangement or antenna port to transmit into the opposite direction using the same antenna arrangement or antenna port.

In accordance with embodiments, and assuming a situation where the measurement uncertainties for the reciprocity channel state information is significantly different, exploiting reciprocity based on transmit precoding at one side of the bidirectional link is beneficial for the other end of the link in terms of reduced measurement uncertainty, in particular during early channel acquisition and initial beam pairing between the nodes. In accordance with embodiments, when one end or side of the bidirectional link is not capable of achieving a reciprocal matching with a radio channel, but the other end is more capable to do that, the more capable end or node may assist the other node with the beam management procedures, for example by providing a channel feedback. The accuracy of the reciprocal channel estimation may be a function of the propagation and efficient radio channels, for example, it may depend on an angular direction of arrival, DOA, spectrum, a received signal strength, an angular resolution of the receive or transmit antenna arrangement, a calibration of the transmit-receive antenna arrangement.

As is mentioned above, in accordance with embodiments, the radio channel measurements allowing for the channel estimation of the respective radio channels between node A and node B in FIG. 9 may be employed for precoding or beam management. Beam management is technique in accordance with which a communication partner, for example, a UE, offers a set of marked beams and the other communication partner, like a base station or another UE, measures and evaluates the received beams based on one or more certain metrics, for example, the signal-to-noise ratio, SNR. The beam best suited for the communication is then determined and the selection is communicated to the communication partner to use the beam selected. Beam management may be applied both for uplink and downlink beams.

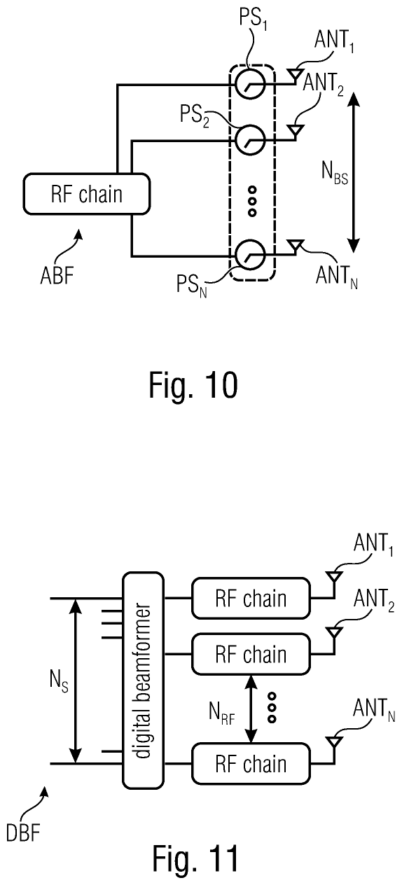

The respective beams used for the beam management are created by beamforming, and, conventionally, beamformers may be realized as hybrid or monolithically integrated analog sub-systems or as digital sub-systems. FIG. 10 illustrates an example of a generic analog beamformer, ABF, that may be employed at a base station where all antenna elements ANT₁ to ANT_{N} share a common or single RF chain or RF front-end through respective phase shifters PS. The overall number of antennas or antenna elements at the device, like the base station, is denoted by N_{BS}. However, the analog process may yield high losses, amplitude and phase misbalances and the like. Such impairments contribute to errors in the beam-pointing and geo-location and to a general antenna pattern contamination. FIG. 11 shows a digital beamformer, DBF, at a base station where each antenna element ANT₁ to ANT N needs a separate RF chain. Nₛ data streams are applied to the digital beamformer that outputs the signals to the respective RF chains, the number of which is denoted by N_{RF}.

In contrast to a fully-digital design in which the spatial processing is performed by the baseband unit implementing the DBF that may use flexible computational resources afforded by digital processors, the analog beamforming schemes need analog components, such as phase-shifters, time delay elements, variable gain amplifiers, and attenuators or switches. While such analog components do not have the same processing flexibility as the digital processor, they may substantially reduce the costs and complexity of the beamforming approach and simplify the implementation.

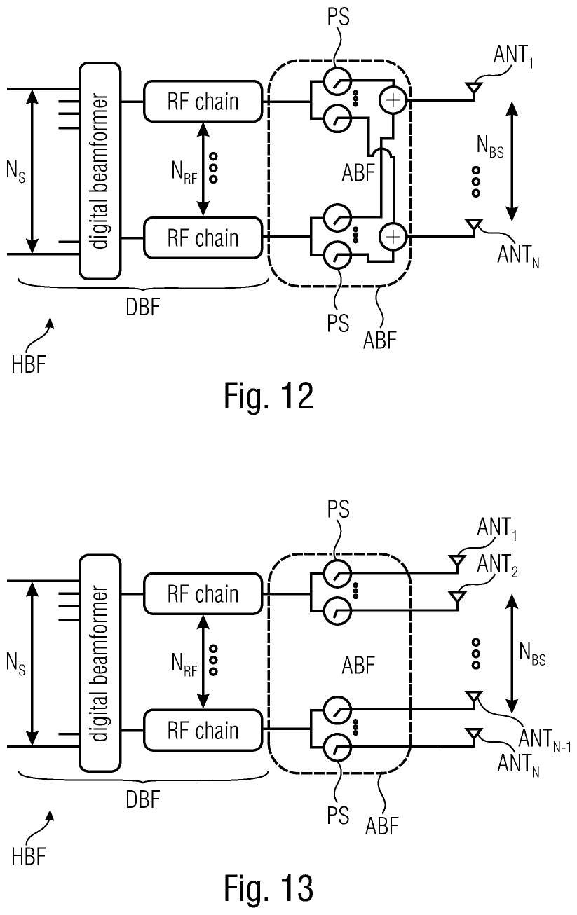

In accordance with further conventional approaches, the analog and digital beamformers may be combined into a so-called hybrid analog-digital beamformer, HBF, an example of which is illustrated in FIG. 12. The fully-connected HBF architecture illustrated in FIG. 12 comprises the DBR illustrated in FIG. 11 receiving the data streams and outputting, via the respective RF chains, respective signals to the analog beamformer ABF which is finally connected to the respective antennas of the device, ANT₁ to ANT_{N}. The structure of the ABF in FIG. 12 is such that each RF chain of the DBF is associated with the ABF structure described in FIG. 10, i.e., each RF chain outputs its signal via the ABF to all of the antennas. In other words, in accordance with the HBF architecture in FIG. 12, all RF chains are connected to all antennas ANT₁ to ANT_{N}, and the ABF contains a large number of phase shifters in order to fully map all RF chains to the antennas. The number of data streams is denoted by Nₛ, the number of RF chains is denoted by N_{RF′} and the number of antennas is denoted by N_{BS}. The hybrid analog digital beamforming architecture allows reducing the number of radio frequency or RF chains by distributing the processing into both the analog and digital domains, thereby reducing the overall costs and digital bandwidth requirements. Conventionally, the HBF architectures are used for both radar and communication systems and include separate processing paths, one in the analog domain and the other in the digital domain. The digital processing using computational resources, while the analog processing employs RF components such as phase shifters or switches. While a phase shifter controls the phase of an RF signal, the switch either connects or disconnects an RF chain to an antenna. The switching operation may be modeled as a binary variable and the phased shifter may be modeled as a unit-norm complex variable. Although there are various hybrid analog-digital beamforming architectures in existence which differ in the method used for connecting the RF chains to the antenna, in general, each RF chain of the digital part is connected with one or more antennas via analog components. The most complex scheme is the hybrid fully connected scheme fully illustrated in FIG. 12, in which each RF chain is connected to all antennas via an analog component.

To reduce the number of connections and analog components other approaches may be used, for example, a localized scheme or an interleaved scheme. In accordance with a localized architecture, each RF chain connects to a subset of sequential antennas, as is illustrated in FIG. 13. FIG. 13 illustrates, other than FIG. 12, a partly-connected HBF architecture. When compared to FIG. 12, the architecture of FIG. 13 differs in the analog domain part as, other than in FIG. 12, each RF chain is connected only to a subset of the available antennas while every antenna is attached to a phase shifter. Again, the number of data streams is denoted by Nₛ, the number of RF chains by N_{RF} and the number of antennas by N_{PS}. In accordance with the interleaved architecture, different RF chains are interconnected with separated antennas. As the RF connection lines tend to be longer in an interleaved scheme compared to a localized scheme, the implementation complexity and losses may be higher, but on the other hand, the interleaved scheme offers greater flexibility in terms of its configurability.

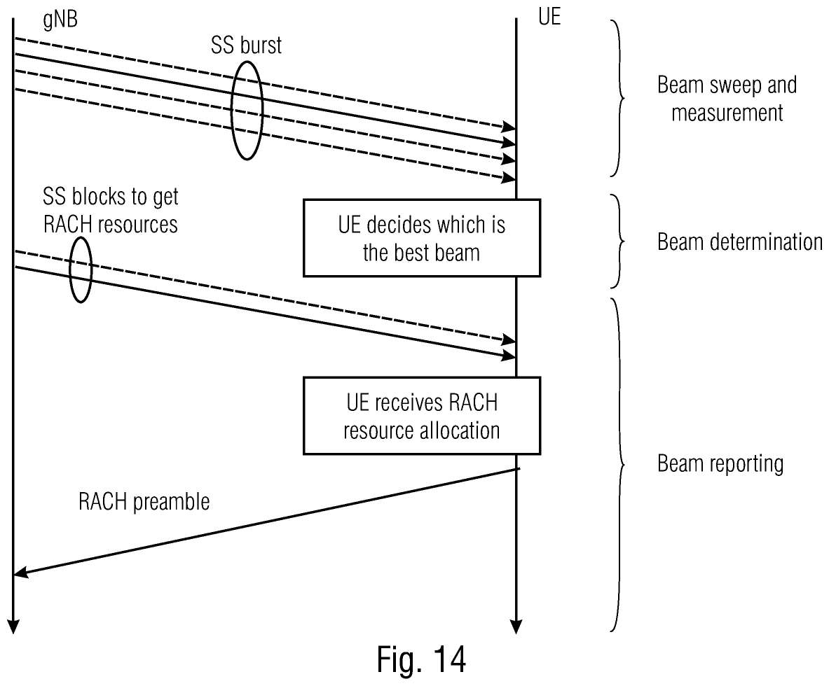

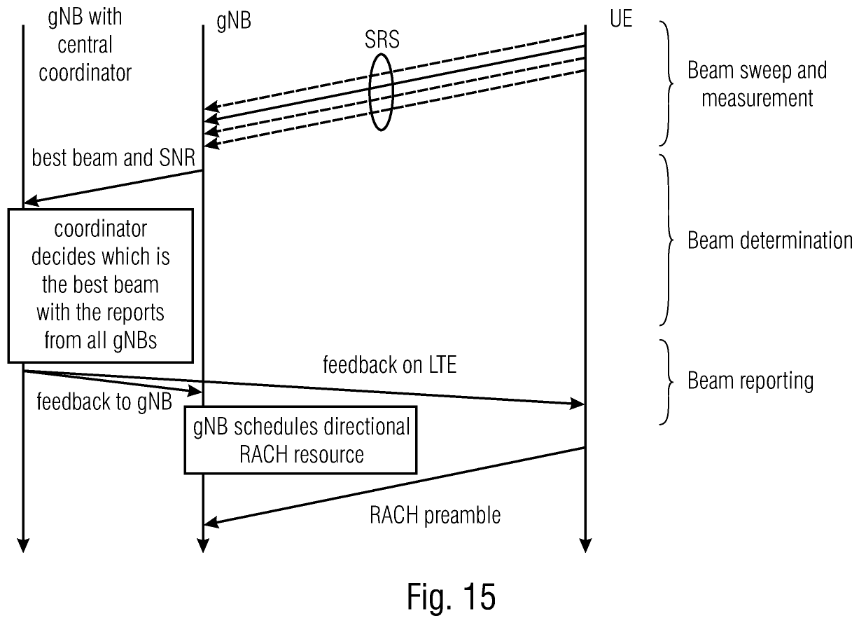

The above-described beamformers may be used for creating the beams employed during the beam management process. FIG. 14 illustrates the signals and messages exchanged during a downlink, DL, beam management procedure for an initial access, IA, while FIG. 15 illustrate and signals the messages exchanged during an uplink, UL, beam management procedure. In FIG. 14 and FIG. 15, a communication between a base station, gNB, and a user device, UE, is assumed. As is illustrated in FIG. 14 and in FIG. 15, the beam management procedure may be divided into four different operations, namely the beam sweeping, the beam measurement, the beam determination and the beam reporting.

During the beam sweeping operation, a spatial area is covered by a set of beams identified by their reference signals, RS. Dependent on the state of the communication, the beams may have different widths and may be pre-coded or not. During an initial access, for example, the gNB may sweep wide, non-pre-coded SSB beams in a SS burst, as illustrated in FIG. 14. For a beam refinement, the beams may be narrower and pre-coded for a specific communication partner and may be identified, for example, by the CSI-RS. The sweeping process may be carried out with an exhaustive search covering the whole angular space or only a sub-space of the whole area. For the uplink beam management procedure, the UE transmits the set of beams which are identified by the SRS, as is indicated in FIG. 15.

During the beam measurement operation, the quality of the received beams is evaluated at the UE (FIG. 14) or at the gNB (FIG. 15) according to suitable metric, like the SNR. Using the measurements, a report table based on the channel quality of all received beams may be compiled locally.

The beam determination operation is based on the just-mentioned report table compiled during the beam measurement operation. The beam most suitable for a communication is selected, and, during an initial access, the receiving entity may also select its own beam for transmission. As is illustrated in FIG. 14, for the downlink beam management procedure, the UE decides which is the best beam. In the uplink beam management procedure, in accordance with embodiments, the gNB may determine the best beam, while, in accordance with embodiments illustrated in FIG. 15, the best beam and the associated SNR may be transmitted to a further gNB having a central coordinator which, in turn, decides which is the best beam on the basis of the reports from all gNBs connected to the gNB having the central coordinator.

During the beam reporting operation, the result of the beam determination operation is transmitted to the communication partner which then adjusts its beam for the subsequent transmissions. During the downlink beam management procedure as illustrated in FIG. 14, the beam reporting operation includes a random access channel, RACH, process in accordance with which the UE, initially, obtains the SS blocks for obtaining the RACH resources, and responsive to the RACH resource allocation, the RACH preamble is transmitted to the gNB. During the further transmission of the RACH preamble, also the beam decided to be best by the UE may be signaled to the gNB. For the uplink beam management procedure, the gNB having the central coordinator may feedback the best beam to the gNB or, in case of an LTE network, to the UE, and the UE starts a RACH procedure by sending the RACH preamble. In accordance with embodiments, when the feedback is received at the gNB, the gNB may perform a scheduling of directional RACH resources towards the UE.

The beam management may be used both for initial access and for beam refinement in the connected state, for example to allow for a mobility of the UE. However, due to the lack of channel reciprocity, conventional approaches do not employ beamforming or beam management in combination for a full duplex transceiver employing a channel or antenna separation technique for self-interference cancelation. However, in accordance with the inventive approach, since the channel reciprocity of the respective channels is established, the use of beam management, in accordance with embodiments of the present invention, is now possible and employed in accordance with embodiments described herein. Stated differently, embodiments of the present invention allow for a beam management for a matched pairing of coordinated or managed beam pairs when simultaneous transmission and reception is supported by either node of a bidirectional communication link.

In order to minimize the overhead of several beam sweeps and associated reporting of the results, 3GPP introduced the so-called beam correspondence which allows a UE to automatically select a suitable beam for an uplink transmission solely based on downlink measurements. This assumes reciprocal transmit and receive capabilities of the UE and similar interference situations in the uplink and the downlink so that a correspondingly chosen transmit beam pattern matches the received angular power profile. The UE may meet the beam correspondence requirements either fully autonomously or with the assistance of the base station. In the latter case, the UE presents the base station with a suitable set of beams which are then handled in a manner similar to the beam management. The beam correspondence relies on the reciprocity of the communication channel so that, so far, beam correspondence was not possible in conventional approaches employing separate channels or antennas for reception and transmission over a bidirectional communication link. However, in accordance with embodiments of the present invention, also the beam correspondence approach may be employed for such FD devices due to the inventive approach allowing to exploit a channel reciprocity of the plurality of channels established between the FD node and the one or more further entities or communication partners of the FD node.

For implementing the beam management for a combination of communication partners of which at least one is a FD apparatus or device employing channel or antenna separation techniques for the self-interference cancelation and operating in accordance with the principles described above with reference to FIG. 9, further information may be exchanged between the communication partners, for example one or more of the following information:
beam and/or beam pair sweeping information
beam and/or beam pair measurements
beam and/or beam pair determinations
precoder and/or decoder selection
precoder and decoder coordination and selection.

Assistance information about antenna ports, like the transmit and/or receive antenna ports, or the beams, like the transmit and/or receive beams, for the beam management may be provided and include, e.g., a beam marking by reference signals or other IDs, for example a type II feedback to request more refined beams to be provided as spatial direction anchors in a given radio channel scenario, for example beams transmitted with a particular antenna port or beam direction, may be marked in order to differentiate between them.

The pairing of the antenna ports may also refer to a transmit antenna arrangement and a receive antenna arrangement combination allowing simultaneous transmission and reception to reduce self-interference between the transmitter and the receiver paths or chains based on the antenna element isolation or crosstalk and other associated SI procedures implemented in the analog domain and/or in the digital domain.

The messages for signaling the above-mentioned information, also referred to as the S4FAPM signaling, may be exchanged between the beam management entities within the same node and/or between the nodes using the bidirectional wireless links between them. The information may be used by one or more units responsible to compute or determine the appropriate beam management and responsible for signaling in a particular constellation, the utilization of the uplink and downlink frequency resources, for example signaling the beam selection, the beamforming, the beam pairing and the like. The messages of the interface, also referred to as the protocol, between the nodes and the respective beamforming units may include configuration messages indicating how the flexible antenna port configuration setting and an associated sequential pattern may be reported, performed and/or what information is to be reported and what message format is to be used.

In accordance with embodiments, the messages on the interface between the nodes and the flexible antenna port selection/pairing unit may include messages about current capabilities of the nodes or units or entities, current setting and acknowledgments with respect to configuration commands by the node or units or entities and the data which is output by the reporting units.

In accordance with embodiments, decisions made by the beamforming unit may be applied at a particular band and/or a particular band combination, in particular timeslots, in particular beams or set of beams which are included in the S4FAPM procedure. The associated commands may be in the form a command to be executed, a recommendation, a suggestion or side information to be considered by the antenna port or beam management units responsible for the further paired operation of the multiple antenna ports at the one or two nodes of the bidirectional wireless link. In accordance with embodiments, decisions or proposals by one or more units for multiple antenna port selection or pairing or beamforming and the associated signaling of the decisions or proposals may include one or more of the following:
a definition, negotiation and selection of antenna ports in associated settings for the transmission and/or the reception,
a definition, negotiation and selection of one or more multiple antenna port pairs, settings, rules and/or configurations of antenna port or beam pairings, or enhancements at the at least one node in the uplink or downlink between the two nodes,
a setting of UL-DL antennal port pairs when operating the UL and the DL in different component carriers or bands,
a timing of particular antenna ports to be active and/or configurable for transmission and/or reception and the associated mapping to the UL or DL bands or the time instances, for example the slots, frames, OFDM symbols, sampling periods, within the transmission frame for UL and/or DL,
a setting of preferences or priorities of antenna port pairing for particular decisions, procedural input, prioritization in case of conflicting multi-objective optimization scenarios, requests and/or confirmations of the S4FAPM signaling information from the UL and DL antenna port pairs and/or antenna port pairing between the transmitter antenna port and the receiver antenna port when operated at the same time.

In accordance with further embodiments of the present invention, the inventive apparatus, for example a communication device configured for communication with another communication entity using bidirectional wireless links in different bands or in the same band, may provide capability information, for example for supporting the above-described S4FAPM process. This may include further information with respect to the parameters of observation capabilities and associated parameterization, metrics and measurement uncertainties. Further, information about the supported message space configuration may be provided, for example a description of the protocol used for the signaling of the information. Further, information about the features and assistant modes supported may be provided, which may include the antenna port properties and/or one or more of the following configurations:
an inter-band distance,
a system bandwidth per band, like the available bandwidth over all component carriers used for UL and/or DL,
an antenna element number, spacing and geometric distribution,
an effective aperture, an effective beam widths,
beam steering angles and steering range,
an effective temporal and angular resolution,
an antenna array orientation, direction, directivity, spatial pattern overlaps and the like for each antenna port or antenna port pair.
a number of antenna port configuration states used by the apparatus,
one or more patterns of switching between antenna port configuration states, like antenna port mapping configurations,
an uplink/downlink relation between antenna port configuration states,
a transmission/reception relation between antenna port configuration states.

The just mentioned relations or relationships may refer to the same and/or different antenna port configuration states, and may refer to a mapping to particular radio resources, e.g.,
in the spectrum domain: carriers, like for FDD, TDD, one or more bandwidth parts, BWP, one or more bands, like licensed, unlicensed, and/or band combinations.
in the time domain: one or more radio frame, one or more slots, one or more OFDM symbols, etc.
in the spatial domain: one or more spatial beams, one or more antenna radiation patterns, one or more polarizations, direction of arrival, DoA, direction of departure, DoD.
the antenna elements: center of radiation reference point, one or more sub-arrays, a proximity of antenna elements, a cross-coupling between antenna ports.
a similarity and/or a dissimilarity of the communication channels and/or components contributing to the communication channels: allowing one of the communication channels to predict changes in another one of the communication channels in case the similarity meets an associated threshold and/or the dissimilarity meets an associated threshold.

Regarding the similarity/dissimilarity of the communication channels, for example, when assuming cross polarized antennas, a Xpol discrimination between Tx and Rx may be around 40-50 dB, while the main directions from the dominant multipath components, as reflected in the power delay profile, may be identical or highly correlated. Using this knowledge, observations about changes of the first communication channel may be used to predict changes of the second communication channel without the need for explicitly measuring again so that the number or needed measurements may be reduced.

Further, the communication device may request the S4FAPM for a particular band and/or band combination so as to obtain further parameters, like a direction or orientation of the device, specific assistance information including sampling rate, aggregation level and the like, and for obtaining a reoccurring port selection density, activation pattern options and/or settings.

In accordance with embodiments, the FDD flexible antenna port mapping between the mapping of the receiver and transmitter onto the uplink or downlink bands may be accompanied with a suitable switching of
a frequency duplexer, in case of two bands, like uplink and downlink, or
a diplexer in case two bands operated for the uplink as well as for the downlink, as in GSM, 4GOor, GSM and GPS, or
a triplexer in which three bands are used for the uplink and downlink, as in 2G, 3G and 4G.

Dependent on the chosen implementation, a local oscillator frequency for the transmitter and receiver may need to be swapped or reconfigured.

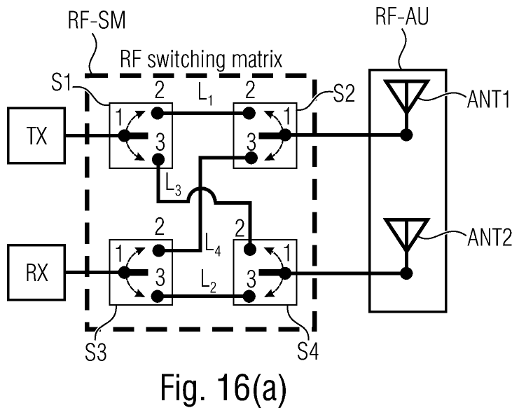

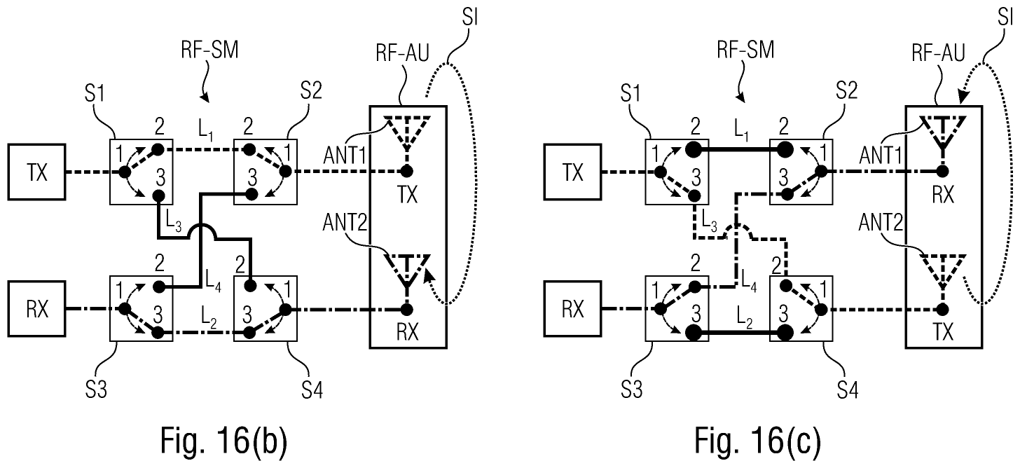

In the following, embodiments for implementing the antenna switching technique for a reciprocal full-duplex bidirectional full-duplex links are described in more detail. Embodiments of the present invention describe an antenna switching technique that retains reciprocity to communication channels in a full-duplex scheme where a dedicated transmit and receive antenna configuration is used. In accordance with embodiments, the inventive approach relies on an RF switching technique where each of the antennas may be dynamically utilized either as a transmit antenna or as a receive antenna. FIG. 16 illustrates an embodiment of the present invention, more specifically a device performing antenna switching in a single input single output, SISO FD transceiver. The FD transceiver is illustrated in FIG. 16(a) schematically and includes at least one RF transmitter chain TX and at least one RF receiver chain RX that are coupled to an RF antenna unit RF-AU via an RF switching matrix RF-SM. In the depicted embodiment, the transceiver includes one RF transmitter chain or TX front-end and one RF receiver chain or RX front-end, and the RF circuit and antenna unit RF-AU includes two antennas ANT₁ and ANT₂. The switching matrix RF-SM includes four switches S₁-S₄. Each of the switches includes three terminals 1, 2 and 3, and each switching element S₁-S₄ is configured to selectively connect the first and second terminal or the first and third terminal of the respective switch. The switching matrix RF-SM further includes the conductors or lines L₁-L₄, of which line L₁ connects the terminals 2 of the first and second switches S1 and S2, line L₂ connects the terminals 3 of the switches S₃ and S₄, line L₃ connects the terminal 3 of switch S₁ and terminal 2 of switch S₄, and line L₄ connects terminal 2 of switch S₃ and terminal 3 of switch S₂.

In accordance with embodiments of the transceiver described with reference to FIG. 16, the switching matrix RF-SM may be operated to selectively switch the antenna elements ANT₁ and ANT₂ so as to operate transmit/receive antennas at a first instance or in a first switching state of the switching matrix, and as receive/transmit antenna at a second instance or in a second switching state of the switching matrix as is illustrated in FIG. 16(b) and in FIG. 16(c).

FIG. 16(b) illustrates a state in which antenna ANT₁ is a transmit antenna while antenna ANT₂ is a receive antenna. In such a state, the switching matrix RF-SM operates the switches S₁-S₄ such that in switches S₁ and S₂ the terminals 1 and 2 are connected thereby connecting the TX front-end via the switches S₁ and S₂ and via the line L₁ to the antenna ANT₁. The switches S₃ and S₄ connect their respective terminals 1 and 3, thereby connecting the RX front-end via the switches S₃ and S₄ and the line L₂ with the antenna ANT₂. FIG. 16(b) further illustrates, schematically, the self-interference SI experienced at the receive antenna due to the transmission at the transmit antenna.

FIG. 16(c) illustrates a second state in which antenna ANT₁ is the receive antenna and antenna ANT₂ is the transmit antenna. Again, the self-interference SI due to the transmission at the transmit antenna is schematically indicated. Switch S₁ connects its terminals 1 and 3 and switch S₄ connects its terminals 1 and 2, thereby connecting the TX frontend via the switches S₁ and S₄ and via the line L₃ to the antenna ANT₂. Switch S₃ connects its terminals 1 and 2 and switch S₂ connects its terminal 1 and 3, thereby connecting the RX frontend via the switches S₃ and S₂ and via the line L₄ to the antenna ANT₁.

Thus, the embodiment in accordance with FIG. 16 provides the matrix RF-SM providing for the possibility for interconnecting the transmit front-end TX, the receive front-end RX and the two dedicated antennas ANT₁ and ANT₂ in such a way that signals may be dynamically routed to the respective antennas. The switches S₁-S₄ operated so as to select one of the operating states described with reference to FIG. 16(b) and FIG. 16(c), namely to route a transmit signal to one of the antennas to play the role of a transmit antenna, while the receive signal is routed to the other antenna to play the role of the receive antenna, as it is illustrated in FIG. 16(b). By reversing the configuration of the RF switches S₁-S₄, the other operation state is achieved where the signal paths are interchanged. In other words, the transmit antenna becomes the receive antenna and the receive antenna becomes the transmit antenna, as is illustrated in FIG. 16(c). Thus, the two operation states put each of the antennas either in transmit mode or into receive mode dynamically.

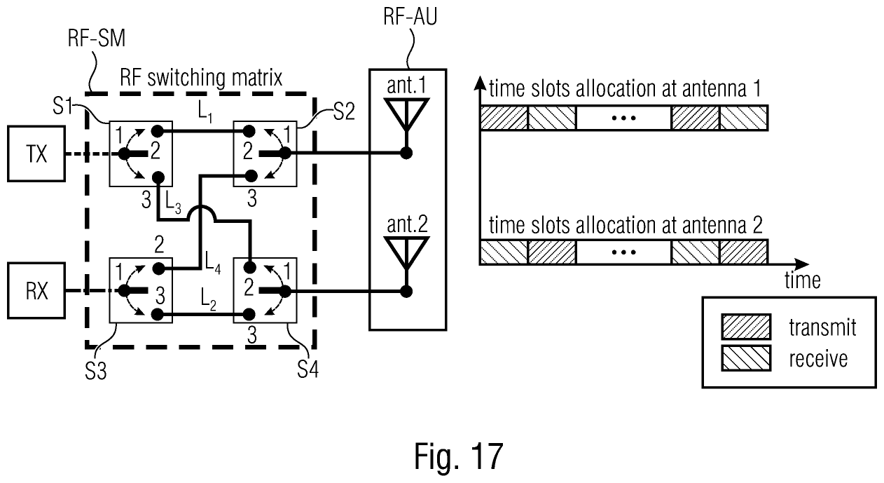

The embodiment described with reference to FIG. 16 may be understood as a combination of a full duplex duplexing scheme and a time division duplexing scheme in one setup exploiting the advantages of both schemes. Where the FD scheme offers its advantage for transmitting and receiving at the same time, the switching among the antennas re-enables the transmit and receive by the same antenna. FIG. 17 illustrates the operation concept on the time axis, more specifically a time-slot allocation using the antenna switching scheme in an FD SISO transceiver is illustrated. In the right hand part of FIG. 17, the structure of FIG. 16(a) is illustrated, while the right hand part illustrates the allocation of the time-slots at the two antennas. As may be seen, antenna ANT₁ transmits over a time-slot before it switches in the next time-slot to a receive mode, while antenna ANT₂ has the opposite operation state. In FIG. 17, a guard interval between the time-slots is omitted for illustration simplicity purposes, however, in particle implementations, between the transmit and receive time-slots respective guard intervals may be provided.

Implementing a FD device in accordance with the embodiment of FIG. 16 allows for exploiting the channel reciprocity in a way as described above with reference to FIG. 9, as in the first state the switching is as in FIG. 16(b) where the device may receive via antenna ANT₂. On the basis of measurements of reference signals received during the first state via antenna ANT₂ the transceiver may perform a channel estimation of a channel between the transceiver's antenna ANT₂ and the communication partner. For obtaining the estimate for the channel between the transceiver's antenna ANT, and the communication partner the transceiver switches into the state of FIG. 16(c) and makes the needed measurement for estimating the channel on the basis of reference signals now received via ANT₁. Following the switching between the two states, the transceiver has a channel estimate for the two radio channels that may be established between antenna ANT₁ and the communication node and between antenna ANT₂ and the communication partner. The estimate may be used by the transceiver for the following transmission/reception settings when communicating with a communication partner, for example during a time until the channel properties start to vary to an extent that exceeds a certain threshold or when a time since the last estimation is longer than a channel coherence time assumed for the communication channels. When this happens, the transceiver may again perform the switching operation to obtain new estimates for the radio channels between the antenna ANT₁ and the communication partner and the antenna ANT₂ and the communication partner.

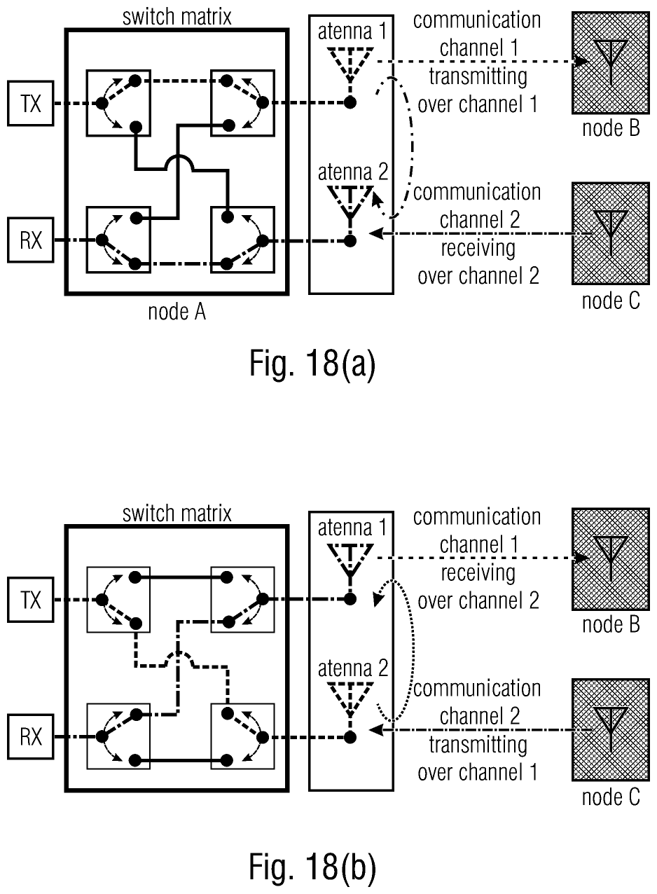

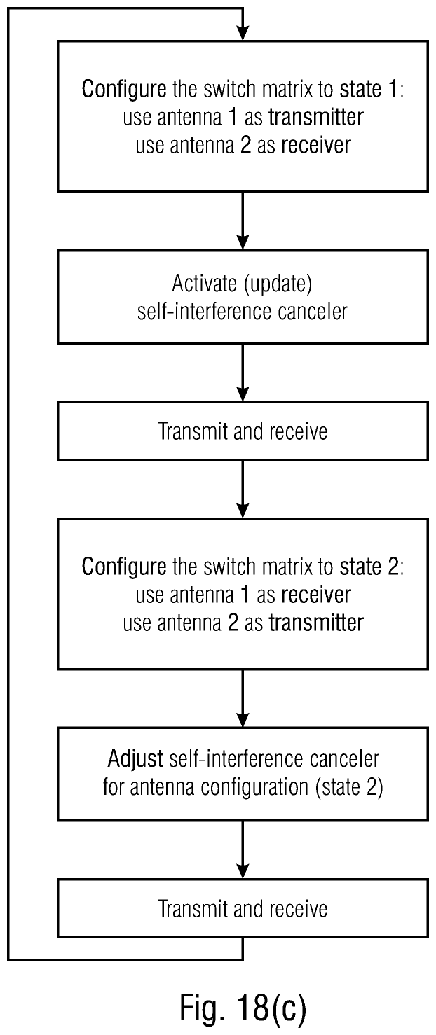

FIG. 18 illustrates an embodiment of an antenna switching procedure for a FD SISO transceiver communicating with two communication partners. FIG. 18(a) illustrates the FD transceiver of FIG. 16 which is named node A. The structure is as described above with reference to FIG. 16(a) and is not be described again. The node A is assumed to communicate with two further nodes, namely node B and node C which are assumed to be non-FD nodes. Node A communicates with node B over a communication channel 1 that is established between antenna 1 of node A and node B. Node A communicates with node C over a communication channel 2 that is established between antenna 2 of node A and node C. FIG. 18(a) illustrates node A being in the first state (see FIG. 16(b)) in which the TX frontend is connected via the switch matrix to the antenna 1 for transmitting over a communication channel 1 to node B. At the same time, i.e., simultaneously, the RX front-end of node A is connected via the switch matrix to the antenna 2 for receiving via communication channel 2 from node C a transmission. FIG. 18(b) illustrates the node A being in the second state (see FIG. 16(c)), in accordance with which the transmit front-end is connected to the antenna 2 for transmitting from node A to node C via the communication channel 2 while simultaneously receiving from node B via antenna 1 that is connected via the switch matrix to the RX frontend. Thus, as illustrated in FIG. 18, because two dedicated antennas are used in the full duplex transceiver A, there are two communication channels, namely, as is shown in FIG. 18(a) and FIG. 18(b) the communication channel between antenna 1 and communication node B and the communication channel 2 between antenna 2 and the communication node C. To transmit and receive over the same channel the antenna is switched between the states illustrated in FIG. 18(a) and FIG. 18(b).

FIG. 18(c) is a flow chart illustrating the switching procedure. Initially, the switch matrix is configured to state 1, so that the switches are in a position as illustrated and explained with reference to FIG. 16(b) thereby using antenna 1 as the transmitter and antenna 2 as the receiver. Following this, the self-interference canceler may be activated or updated and then the transmission and reception to node B/from node C is performed. Then, the switch matrix is configured to be in state 2, i.e. the switches are in a configuration as explained with reference to FIG. 16(c), thereby using antenna 1 as the receiver and antenna 2 as the transmitter. In accordance with embodiments, switching from state 1 to state 2 may need an adjustment of the SI canceler which may be needed due to potential discrepancies among the response on the paths in the switch matrix at state 1 and in the switch matrix at state 2. These discrepancies, however, are deterministic and therefore may be obtained from a calibration procedure and respective calibration data may be stored. After adjusting the self-interference canceler for the antenna configuration in state 2, the transmission and reception to node C/from node B is carried out. Thus, both transmit and receive communications to node B are accomplished over channel 1 while both transmit and receive communications to a channel C are accomplished over channel 2. Each of the communication channels, namely communication channel 1 and communication channel 2, may be estimated over the uplink or the downlink and once the communication channel response is estimated, either of the downlink or the uplink, it may be used for the opposite link direction as the transmit and receive antennas are switched to retain channel reciprocity.

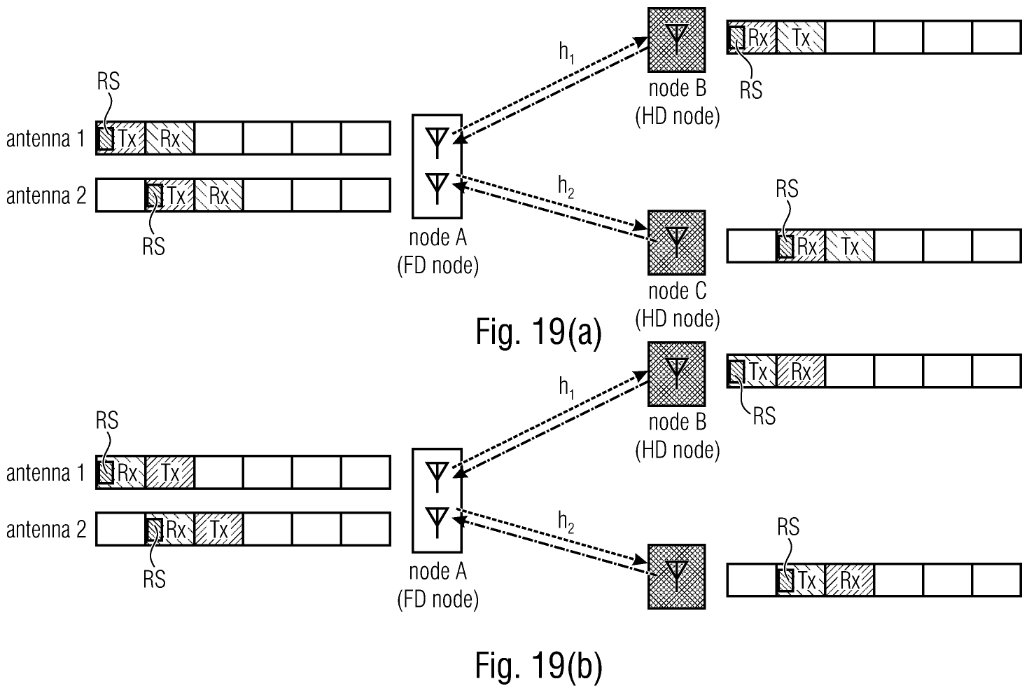

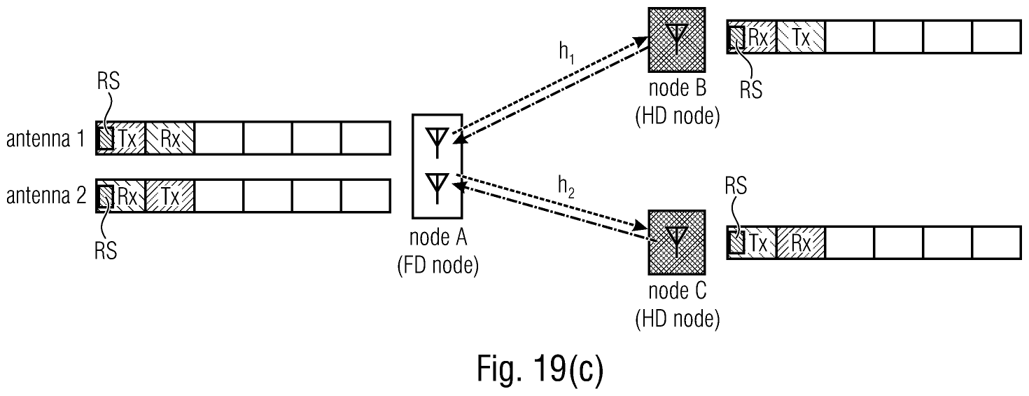

With reference to FIG. 19, an embodiment of a reciprocal channel estimation procedure is described. To estimate a wireless communication channel between two communication nodes a known sequence of signals, like predefined reference signals or sounding signals are transmitted. The sounding signals may be either sent in the transmission direction or in both directions so that, in accordance with embodiments, three estimation options are available. FIG. 19 illustrates embodiments of the three available options for the reciprocal channel estimation, and the respective sound sequence or reference signals are illustrated in the shown time slots as small boxes labelled RS. In FIG. 19, a communication between a node A, an FD node like the one described above with reference to FIG. 16, and two further communication partners, namely nodes B and nodes C is illustrated. Between antenna 1 of node A and node B the communication channel h₁ exists, and between antenna 2 of node A and node C the communication channel h₂ exists.

FIG. 19(a) illustrates an embodiment of a one direction channel estimation from node A to nodes B and C which, in the depicted embodiment are half duplex HD nodes. The estimation process in accordance with FIG. 19(a) may also be referred to as a downlink channel estimation. As is illustrated in the respective time slots associated with the nodes A to C, antenna 1 of node A, when being configured as a transmit antenna, transmits to node B over channel h₁ the reference signal RS so that the node B may estimate the channel h₁ on the basis of the received reference signal RS. The node B may signal the estimation of the channel h₁ to the node A when transmitting in the next time slot to node A. Then, both nodes are aware of the estimates of the channel h₁ and the transmission/reception parameters may be adjusted accordingly. Further, node A when transmitting via antenna 2 to node C transmits the reference signal RS to the node C which may then estimate the channel and also inform the node A when transmitting in the next time slot.

FIG. 19(b) also illustrates a one direction channel estimation, however, now from the plurality of nodes B and C, which, again, may be HD nodes, which is also referred to as an uplink channel estimation. As is illustrated in FIG. 19(b) nodes B and C transmit over channels h₁ and h₂, respectively, the reference signals RS in the time slots when nodes B and C transmit. Accordingly, when node A is switched into a state in which antenna 1 receives, node A receives the reference signals for the first communication channel h₁, estimates the channel and may inform the node B about the estimate results when transmitting in the next slot. Likewise, when node A is switched to a state in which the antenna 2 receives, node A receives the reference signal, estimates the channel and may transmit the estimate to node C when transmitting in the next time slot to node C.

In accordance with further embodiments, the uplink and downlink channel estimations may be combined so that the reference signals are transmitted/received simultaneously at node A. More specifically, as is illustrated in FIG. 19(c), at a first time slot when the node A is switched such that antenna 1 transmits and antenna receives, node A transmits the reference signal RS via communication channel h₁ to node B and, at the same time, receives via antenna 2 over channel h₂ the reference signal RS from node C, thereby allowing estimating the channel h₁ at node B and the channel h₂ at node A.

In accordance with further embodiments, node A may transmit one or more reference signals over the first and second communication channels to the nodes B and C so as to allow them to perform a channel estimation. Using the channel estimation, nodes B and C may determine the channel state and feedback to node A respective channel state information, CSI. The CSI received may be used by node A as an estimate, i.e., node A may adapt its transmissions to the channel conditions.

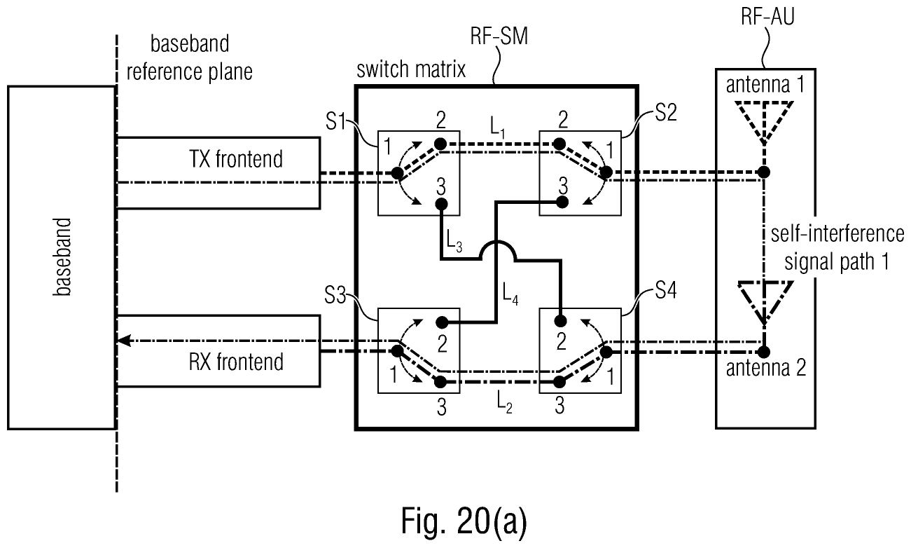

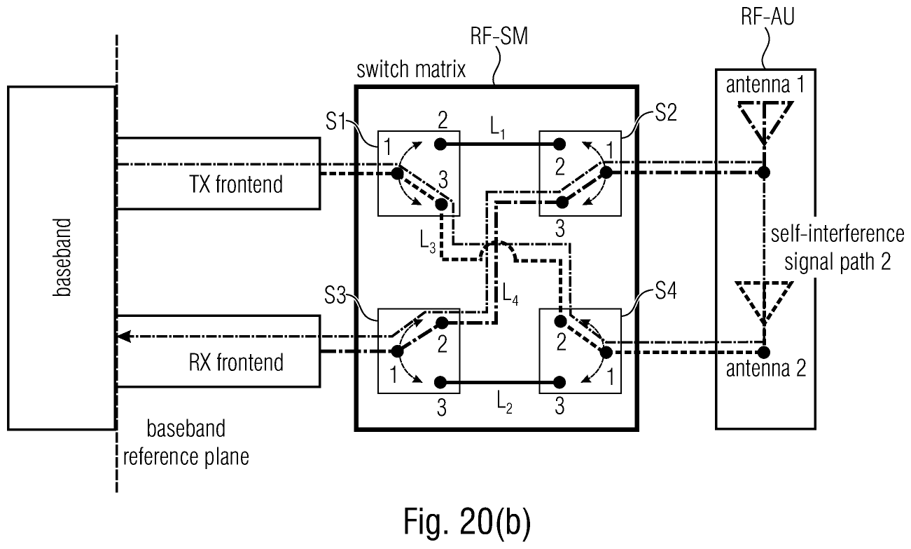

As mentioned above, in accordance with embodiments, when switching between states 1 and 2, an adjustment of the SI canceler may be needed. This may be achieved by performing a calibration procedure and storing calibration data to be employed. FIG. 20 illustrates the calibration procedure, more specifically the SI interference signal path discrepancies due to the switching matrix. FIG. 20(a) illustrates the SI signal path 1 when the switch matrix is in a state as illustrated in FIG. 16(b). The self-interference signal path 1 extends from the baseband unit through the TX front-end via the switches S1 and S2 and via the line L₃ to the antenna 1 which acts as the transmit antenna and therefore a part of the signal radiated by antenna 1 is received by antenna 2 so that the self-interference signal path 1 extends from antenna 1 to antenna 2, and from antenna 2 to the baseband through the switches S₃, S₄ and the line L₂ of the switch matrix and through the RX front-end. FIG. 20(b) illustrates the self-interference signal path 2 when the switch matrix is in the second state which is illustrated in detail in FIG. 16(c). The self-interference signal path 2 extends from the baseband through the TX front-end. The self-interference signal path 2 extends from the baseband through the TX front-end, via the switch matrix and the antenna is back to the baseband through the RX front-end, as is also the case in FIG. 20(a). However, the signal path is different within the signal matrix because rather than extending along lines L₁ and L₂, the self-interference signal path 2 extends along lines L₃ and L₄. Thus, two different physical signal paths exist in the signal matrix so that discrepancies among the paths may occur. The signal paths through the switch matrix are different in the two switching states, as explained above with reference to FIG. 20, however, the SI signal paths 1 and 2 may be measured by an appropriate calibration procedure and any discrepancy among the two paths, like different delays due to different lengths or discrepancies in frequency responses and the like, may be stored. These stored parameters may be used in the device to adapt the SIC signal when antenna switching is executed. For example, when assuming that an SI channel is estimated when the switch matrix is in state 1, as illustrated in FIG. 20(a), when switching the device to state 2, the appropriate SIC signal for the state 2 in FIG. 20(b) may be obtained using stored differences from a former calibration process.

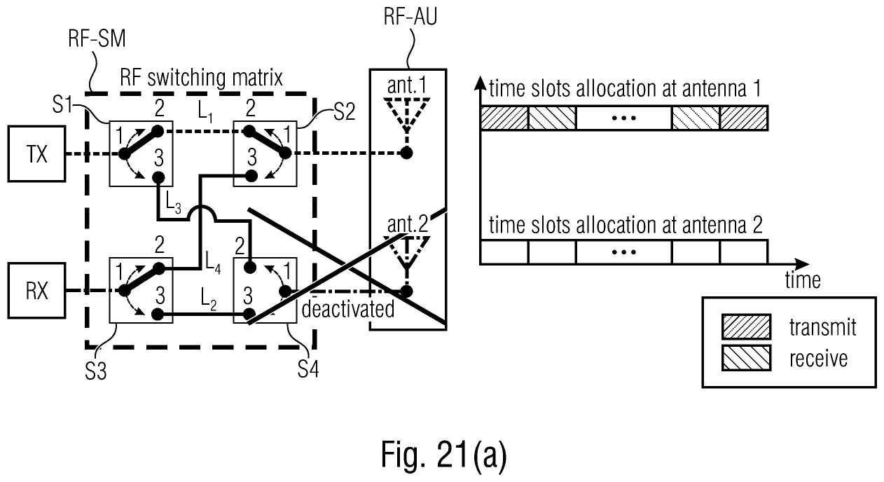

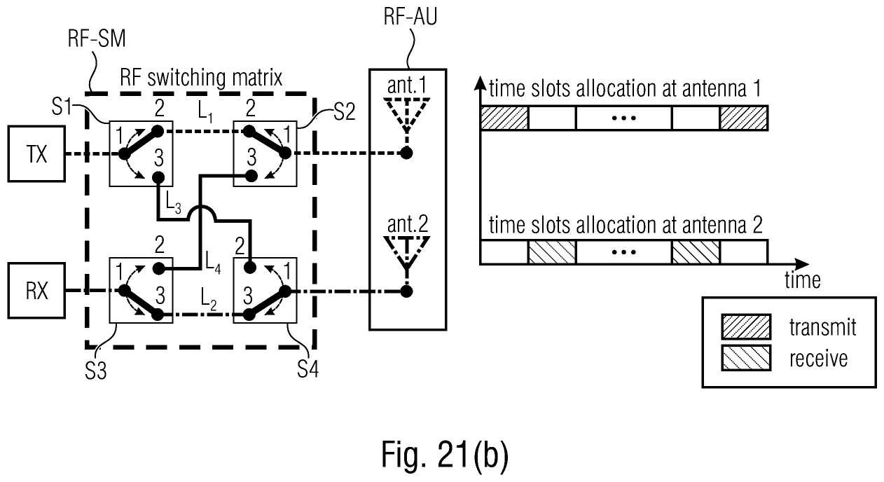

The FD transceiver in accordance with the embodiment described above with reference to FIG. 16 is further advantageous due to its backward compatibility because it may fall back any time to a normal TDD duplex operation. This fallback operation mode may be activated based on several conditions, for example in case the demand on throughput is reduced so that full-duplex operation or the self-interference canceller may be deactivated to save power, or in case the self-interference canceller is malfunctioning, for example, is not capable to sufficiently suppress the self-interference. FIG. 21 illustrates embodiments of the backward compatibility of the inventive FD transceiver of the embodiment of FIG. 16, more specifically the backward compatibility of the antenna switching technique described above with reference to FIG. 16 to operate in a normal TDD duplexing mode so as to provide backward compatibility from FD to TDD.

FIG. 21(a) illustrates an embodiment in which only a single antenna is used in the FD transceiver for receiving and transmitting. For example, switches S1 and S3 are maintained for the TDD operation in a fixed position for connecting terminals 1 and 2 of the respective switches and only switch S2 is selectively switched for connecting terminals 1 and 2 or terminals 1 and 3 of switch 2, thereby either connecting the TX front end via switches S1 and S2 and via line L1 to the antenna 1, or for connecting the RX front end via switches S3 and S2 and via line L4 of the switching matrix also to antenna 1. Thus, no time slots for reception and transmission are allocated to antenna 2 which is fully deactivated in this mode and the node operates as in a usual TDD mode with alternating transmit and receive time slots as also indicated in FIG. 21(a).

FIG. 21(b) illustrates another example, for providing backward compatibility from FD to TDD using the two antennas ANT1 and ANT2 of which ANT1 is the transmit antenna and ANT2 is the receive antenna while the switching matrix does not perform any active switching. Thus, switches S1 to S4 are not active and are in a switching position as indicated in FIG. 21(b) for connecting the antennas as in state 1 illustrated in FIG. 16(b). It is noted that in terms of backwards compatibility, with a fixed RF switch configuration as indicated in FIG. 21(b), and an appropriate SIC, a non-reciprocal FD duplexing operation may also be realized.

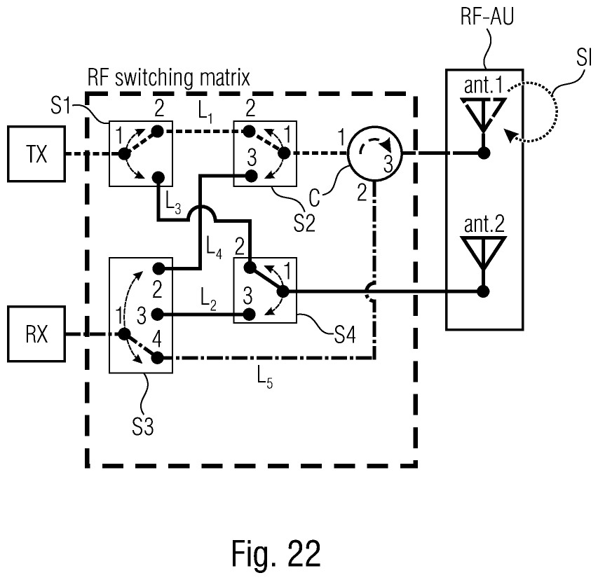

In accordance with further embodiments, the FD transceiver of FIG. 16 may provide for a backward compatibility to a shared transmit- and receive antenna in FD mode. While this, basically, may contradict the concept of the FD transceiver using separate transmit and receive antennas for reducing the self-interference, this fallback mode may be used when the reciprocity is of more priority, and in case the requirements concerning the self-interference cancellation are reduced. FIG. 22 illustrates an embodiment of the FD transceiver of FIG. 16 in which the switching matrix includes a circulator C having the terminals 1, 2 and 3. The circulator C is connected between terminal 1 of switch S2 and the terminal or connection of antenna 1 so that the terminal 1 of the circulator C is connected to terminal 1 of switch S2 while the terminal 3 is connected to antenna 1. The third switch of the switching matrix has, in addition to the terminals 1 to 3 a further terminal 4 which is connected to the terminal 2 of the circulator C. By switching the RX front end via the switch S3 and the line S5 to the terminal 2 of the circulator C and by switching the TX front end via the switches S1 and S2 and via the line L1 to the terminal 1 of the circulator C the FD transceiver is in a backwards compatible mode supporting an FD mode through a shared-transmit and receive antenna, namely the antenna 1. Antenna 1 is used to simultaneously transmit and receive while antenna 2 is disabled. Thus, since the same antenna is shared for transmission and reception, the wireless communication channel originating at antenna 1 becomes inherently reciprocal.

In accordance with embodiments described so far, the antennas 1 and 2 of the FD receiver were assumed to be of the same structure or polarization. However, it is to be noted that in accordance with further embodiments, the separate antenna elements of the FD transceiver may be of different structure or polarization. For example, antenna 1 may be of a first polarization while antenna 2 may be of a second polarization. Embodiments of the present invention in which the antennas of the FD transceiver have different polarizations, may also provide a backward compatibility to a point to point FD mode.

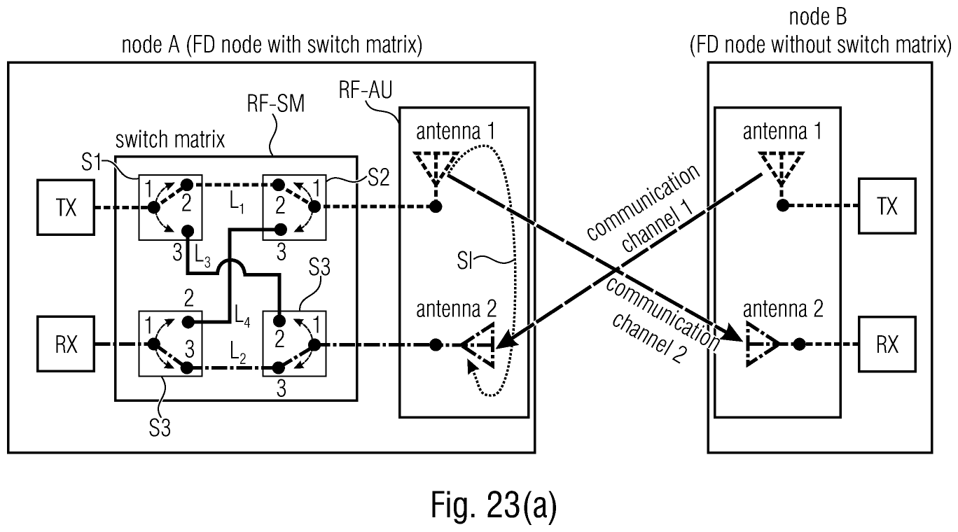

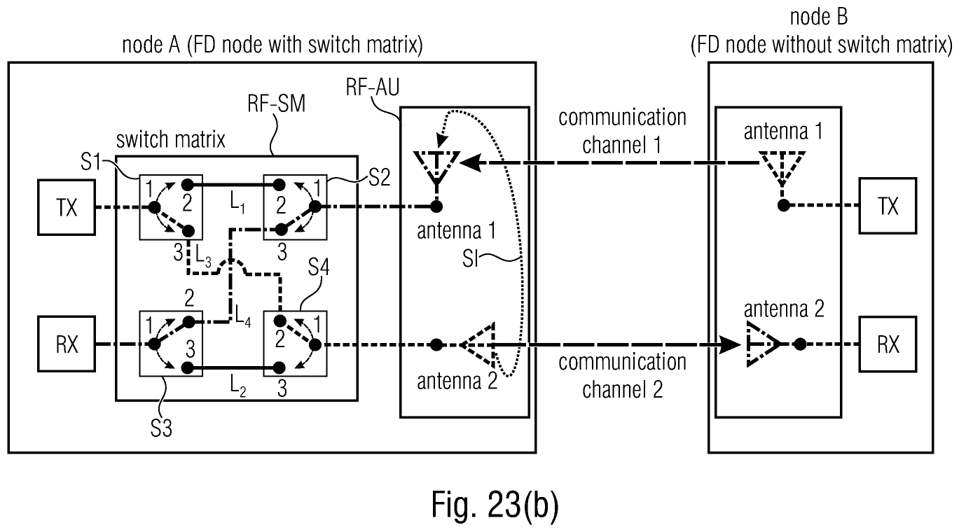

FIG. 23 illustrates two nodes, namely node A and node B of which node A may be a node as described with reference to FIG. 16 having a switch matrix. Other than in FIG. 16, the FD transceiver in accordance with embodiments includes a first antenna having a first polarization and a second antenna having a second polarization different from the first polarization as is illustrated by the antenna symbol being rotated by 90 degrees in the figure. Further, a node B is illustrated which is a simple FD node not having any switching capability and that has a fixed connection of its first antenna to a TX front end and a fixed connection of its second antenna, which has a different polarization than the first antenna, to its receive front end. Thus, each of the nodes, when making a bidirectional full duplex link with each other, uses a dedicated antenna to transmit and a dedicated antenna to receive. However, in a switching state of node A as shown in FIG. 16(b), the dual polarization antenna configurations employed in nodes A and node B lead to communication channels between antennas of different polarizations, as is illustrated in FIG. 23(a). The polarization orthogonality may causes a mismatch. Such a mismatch may not only experienced when pairing antennas of different polarization, but may also occur due to different antennas or antenna structures used in the nodes A and B. In other words, the mismatch on the communication channels 1 and 2 as illustrated in FIG. 23(a) may not only be due to the different polarizations but it may also be due to the use of antennas of the same polarization but of different structure. When employing the inventive FD transceiver of FIG. 16, the problem with the mismatch and a high attenuation on the communication channels in a scenario as in FIG. 23(a) may be overcome by switching node A to the state illustrated in FIG. 16(c), thereby providing the communication channels 1 and 2 between antennas having the same polarizations. As is illustrated in FIG. 23(b), the communication channel between nodes A and B is switched in such a way that the communication channels are between antennas of the same configuration, like the same polarization, thereby reducing the mismatch and the associated attenuation.

The switching between the transmit and receive antennas, in accordance with embodiments, may be triggered based on a previous measurement phase where both channels are estimated. For example, node A may try both antenna configurations and then decide on the basis of the measurements which configuration provides for a better link quality on the communication channels and select this configuration for the communication with node B.

In the embodiments described so far, the FD transceiver included separate antennas for receiving and transmitting, however, the inventive concept is not limited to the use of separate antennas. Rather, in accordance with the inventive concept it is decisive that the two or more communication channels provided by the inventive FD transceiver for communication with one or more further network entities, like one or more nodes operating in FD, are provided simultaneously and may be switched so as to provide at the node A a transmit channel and a receive channel or vice versa. In other words, in accordance with the inventive concept, in a first state a first communication channel between the antenna unit of the FD receiver and a further node is connected to the TX front end, while a second communication channel between the antenna unit of the FD transceiver and a node is connected to the RX front end, while in the second state, the first channel is connected to the RX front end and the second communication channel is connected to the TX front end.

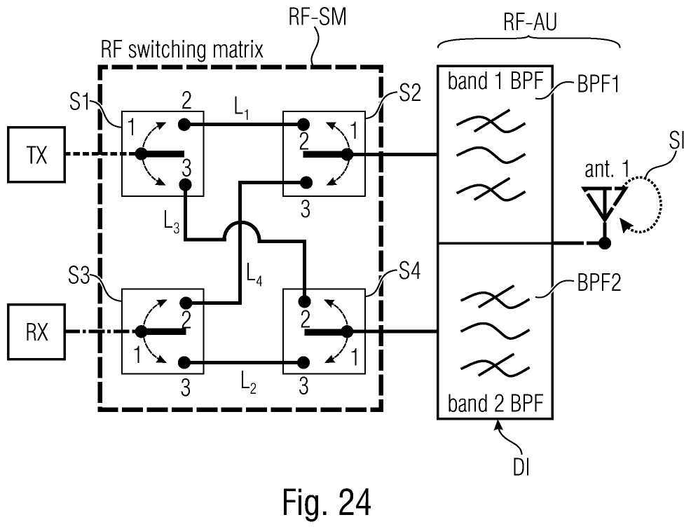

In the embodiments described so far, to realize this, separate antenna elements were used and the antennas were selectively used as transmit and receive antennas or as receive and transmit antennas. However, the inventive approach, as mentioned above, is not limited to the use of separate antennas, rather, also a single antenna or more or more antennas may be employed so as to provide the first and second communication channels in different frequency bands transmitted at the same time by an antenna structure. FIG. 24 illustrates a further embodiment of the inventive FD transceiver allowing for a switching of the communication channels in a way described above for exploiting the reciprocity on the channels. Similar as in FIG. 16, the FD transceiver includes the TX front end and the RX front end that is connected via the switching matrix to the RF-AU unit. Other than in the embodiments described so far, the RF-AU unit includes the diplexer DI that is connected to one or more antenna elements or to an antenna array. The diplexer includes a first bandpass BPF 1 and a second bandpass BPF 2 for defining the frequency bands for the first and second communication channels to the other entity or communication partner of the FD transceiver. By means of the switching matrix, the respective communication channels are selectively connected to the TX front end or to the RX front end thereby achieving the same functionality as described above with reference to the embodiments using separate antennas. In case of a frequency duplex filter the transmit and receive chains are swapped with respect to the band filter inputs/outputs.

In the description so far, only two communication channels have been described that are established for a simultaneous communication between the inventive FD transceiver and one or more communication partners. The two channels are either defined by the separate antenna elements (see FIG. 16) or by the bandpass filters (see FIG. 24). However, the present invention is not limited to the provision of only two communication channels, rather more than two communication channels may be employed so that, depending on the number of separate channels, an appropriate number of antenna elements or bandpass filters is used.

In the following, further embodiments of the present invention are described.

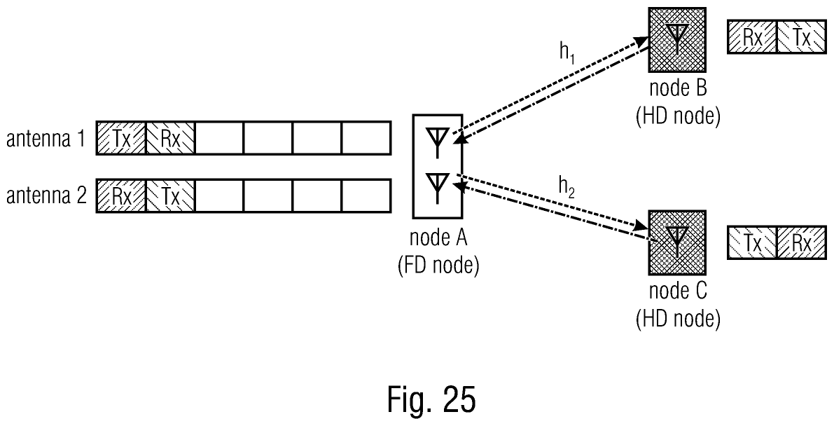

One embodiment concerns a single input single output, SISO, full duplex use case. FIG. 25 illustrates the time slot allocation among a SISO FD equipment with an RF switching technique in accordance with the present invention and two TDD nodes. More specifically, node A illustrated in FIG. 25 may be an FD receiver in accordance with FIG. 16 or in accordance with FIG. 24 which is controlled in such a way that at a first time slot antenna 1 transmits while antenna 2 receives and at a second time slot antenna 1 receives and antenna 2 transmits. The node A communicates with two communication partners, namely nodes B and C both of which are HD nodes. The communication between node A and node B is over communication channel h₁ while the communication between node A and node C is over communication channel h₂. The scenario of FIG. 25 may be considering the most straightforward use case, in accordance with which the SISO FD node A is equipped with the RF switching matrix in accordance with the inventive approach and is connected to the two HD TDD nodes B and C. By properly configuring the switching matrix a reciprocal bidirectional link between the FD node A and the TDD nodes B, C is made sure, and FIG. 25 illustrates the resource allocation among two active bidirectional links where the DL and UL are sent and received via the same antenna.

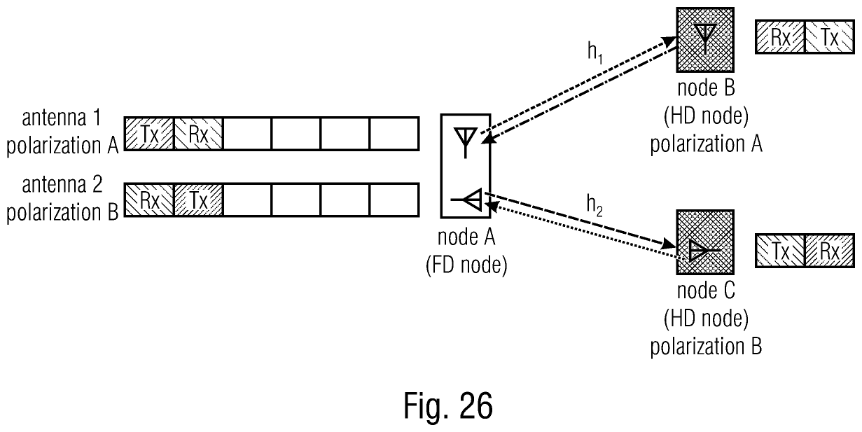

FIG. 26 illustrates an embodiment in which the node A has a dual polarization antenna configuration. Antenna 1 of node A is assumed to have a polarization A while antenna 2 is assumed to have a polarization B. In such a dual polarization antenna configuration, the reciprocity may be diminished, however, in accordance with the inventive switching approach, the reciprocity among the opposite links is maintained because the connection to the node B having the same polarization as antenna 1 of node A is only over the first channel h₁ while the communication with node C having the second polarization which is the same as the polarization of antenna 2 of node A only occurs over channel h₂, thereby ensuring on both channels the desired reciprocity.

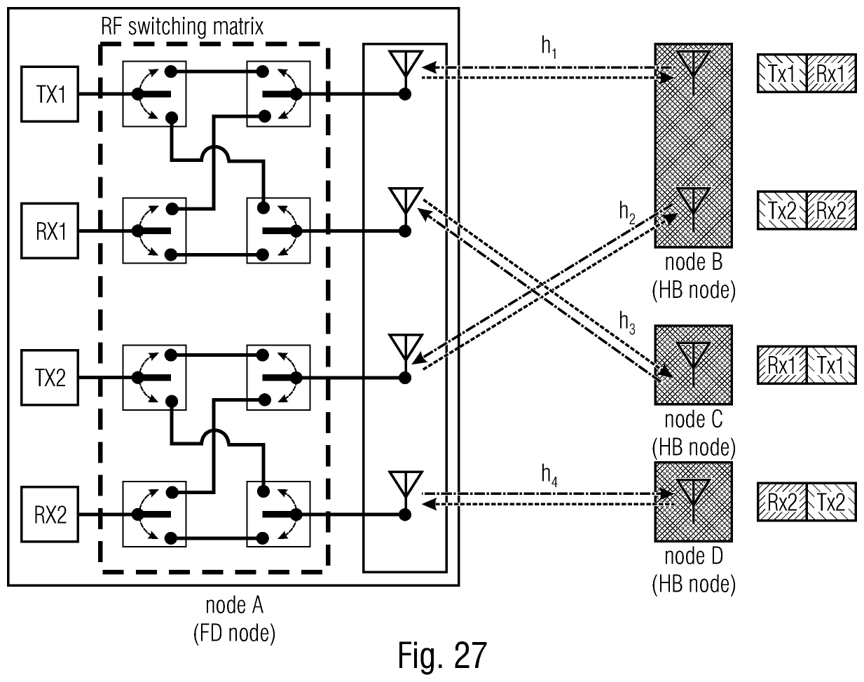

Further embodiments of the present invention address MIMO full-duplex use cases in which also each antenna is to be configurable to be operating as a transmit antenna or as a receive antenna. FIG. 27 illustrates an embodiment of a 2×2 MIMO FD transceiver equipped with the inventive antenna switching technique. It is noted that the 2×2 MIMO configuration is only an example and that the present invention is not limited to this 2×2 configuration, rather, any higher configuration orders are supported in the same way. FIG. 27 illustrates the time slot allocation among the MIMO FD node A including the inventive RF switching technique and three TDD nodes B to C of which node B is a HD MIMO node and nodes C and D are HD SISO nodes. The node A illustrates a further embodiment of the present invention in accordance with which four antenna elements are provided in such a way that the switching matrix selectively connects two of the antenna elements to the first transmit front end TX1 or to the first receive front end RX1 while selectively connecting the other two antennas to the second transmit front end and to the second receive front end. FIG. 27 further illustrates the respective channels h₁ to h₄ between node A and the nodes B to C. At a first time slot two of the four antennas are selected as transmitter antennas while the other two antennas are receive antennas. In the second time slot the selection is reversed so that the transmitter antennas become the receive antennas and vice versa. The change of antenna states may be from one time slot to the next time slot, however, the states may be kept for a longer number of time slots dependent on the system demand and a potential fix configuration. As may be derived from FIG. 27, both a SU-MIMO and a MU-MIMO are supported dependent on the system requirements and demands.

In accordance with further embodiments, when considering the MIMO full-duplex use case, rather than assuming an antenna configuration with the same properties, further embodiments may provide a FD transceiver having an antenna configuration or setup with different properties, like two orthogonal properties, and in such embodiments, the switching of the inventive FD apparatus may be performed in different ways dependent on certain factors, such as the antenna configurations at the respective communication nodes or, stated differently, dependent on the polarization diversity needs with respect to the antenna configuration and the relative orientations among the two sides of the communication. In accordance with other embodiments, the switching may be dependent on the achievable SIC with respect to the transmitter and receiver antenna selection, bearing in mind that the self-interference level may be different among the antennas dependent on their relative orientation, separation and antenna design.

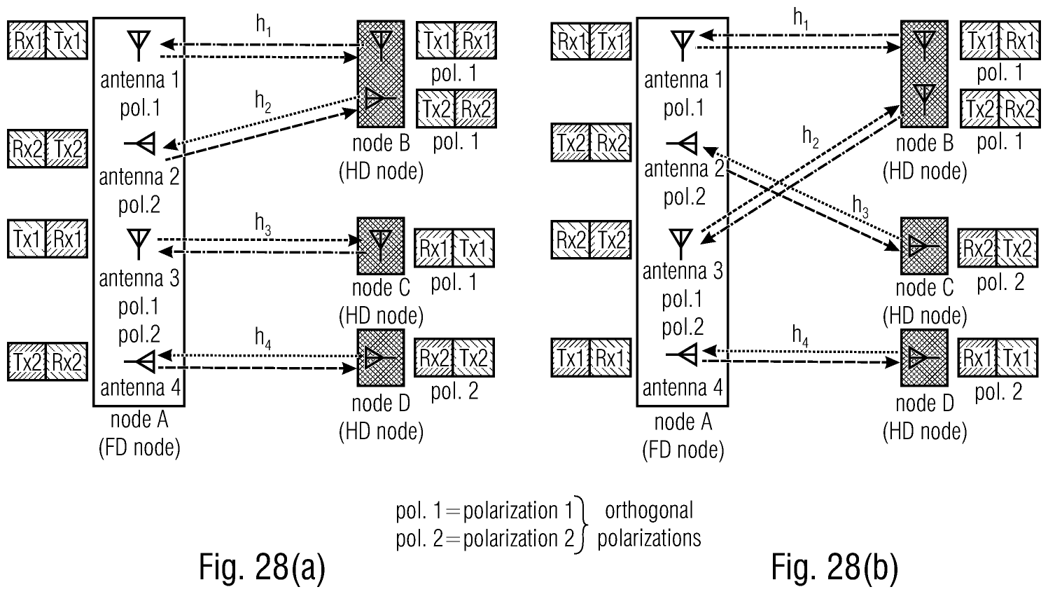

FIG. 28 illustrates embodiments of a dual-polarization MIMO FD transceiver in accordance with embodiments of the present invention equipped with the RF switching technique and including four antennas of which antennas 1 and 3 have a first polarization and antennas 2 and 4 have a second, different polarization. The above-mentioned factors may be taken into consideration for a selection of the antenna switch trigger condition for meeting certain system requirements. FIG. 28 shows different switching configurations in case of dual polarized antenna configurations. FIG. 28(a) illustrates that the transmission or reception over a time-slot utilizes two antennas which are dually polarized, for example orthogonal polarized, while FIG. 28(b) illustrates the transmission and reception of a timeslot that utilizes two antennas with identical polarizations.

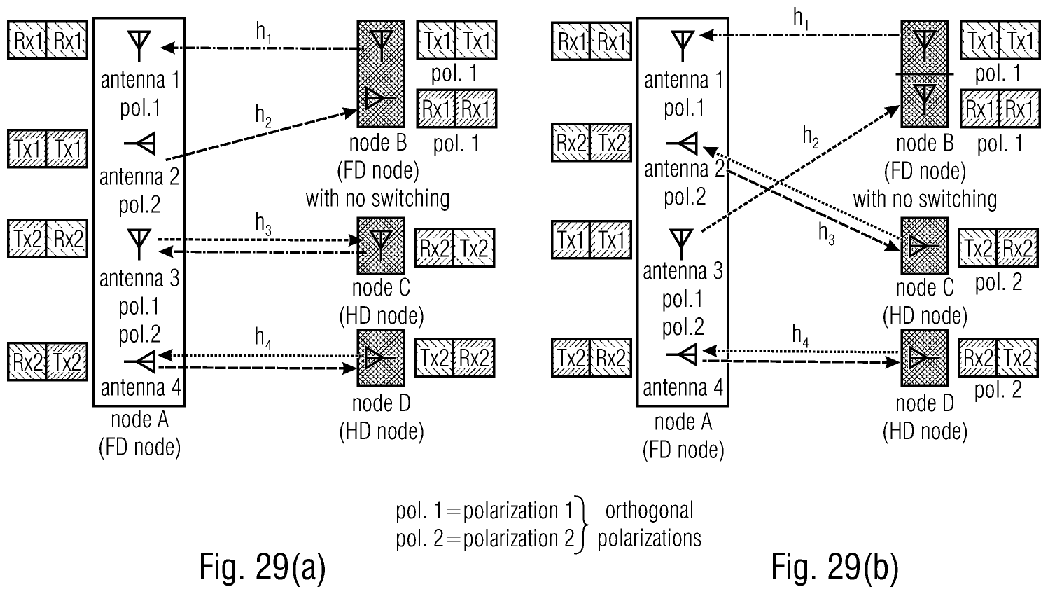

Further embodiments of the present invention relate to a point-to-multipoint, P2MP, full duplex use case with heterogeneous HD and FD nodes. In case of a P2MP network deployment, a heterogeneous case may occur as some of the nodes are FD capable while the rest are only HD capable, for example TTD capable. FIG. 29 to FIG. 31 illustrate different scenarios that may occur in the presence of both HD nodes and FD nodes in the network, and a switching pattern at the node A, which is a node in accordance with embodiments of the present invention, may be affected by the capabilities of the other nodes. The embodiments described with reference to FIG. 29 to FIG. 31 use a FD transceiver employing four antennas with two different polarizations. FIG. 29 illustrates the timeslot allocation among the dual polar MIMO FD node A operating in accordance with the present invention with a FD node B and HD nodes C and D. It is noted that the FD node B is not equipped with the inventive antenna switching capability or, more generally, with the inventive antenna communication channel switching capability. FIG. 29(a) illustrates a scenario including a dual-polar FD node B while FIG. 29(b) illustrates a co-polar FD node B.

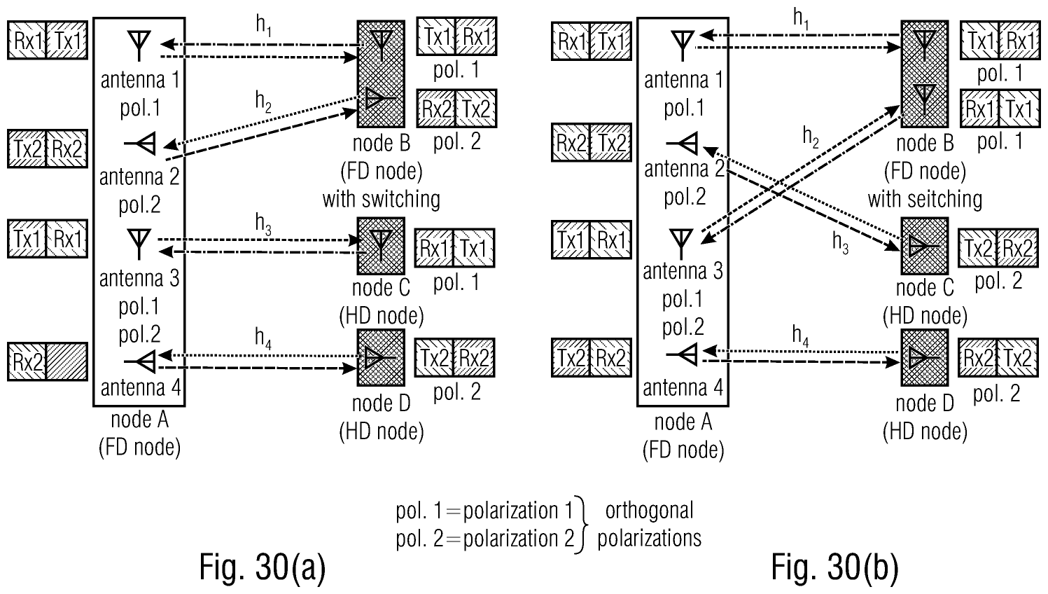

FIG. 30 shows a similar scenario as FIG. 29, except that the FD node B is assumed to be a node in accordance with the teachings of the present invention, i.e., is an FD transceiver in accordance with embodiments, i.e., being provided with the RF switching technique for switching the communication channels.

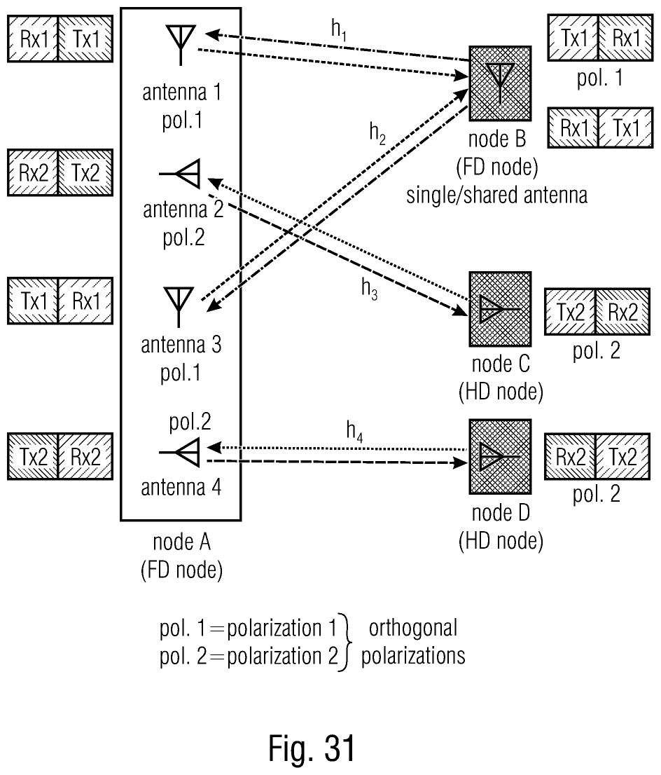

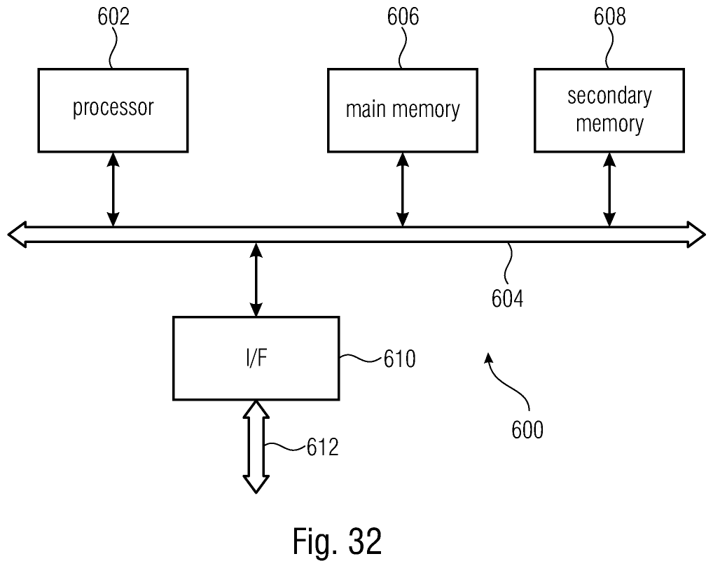

FIG. 31 illustrates a scenario in which the node B is a SISO FD node using a single or shared antenna for transmission and reception.

In the scenario of FIG. 29, FD node B has a dedicated transmit and receive antenna configuration but no antenna switching capabilities so that a switching at node A does not offer node B any advantages in terms of reciprocity. In the scenario of FIG. 30, the FD node B has dedicated transmit and receive antennas and also includes the inventive antenna switching capability so that a synchronized switching between nodes A and B retains the reciprocity or, stated differently, results in two reciprocal channels. In the scenario of FIG. 31, the FD node B is a single shared transmit and receive antenna configuration so that switching at node A maintains the reciprocity and provides two reciprocal channels.

In all three scenarios depicted in FIG. 29 to FIG. 31, the reciprocity capability at the nodes in the network may be signaled and communicated so as to configure the switching pattern in a way that allows retaining the reciprocity on the bidirectional link whenever possible. Further, the signaling avoids unnecessary antenna switching thereby avoiding overhead and a link throughput degradation. The FD node may signal their full-duplex communication capabilities in addition to a reciprocity feature. For example, node B in FIG. 29(a) may communicate its FD capability with unsupported reciprocity feature while node B in FIG. 29(b) may communicate its FD capability with limited reciprocity feature as it uses a dedicated transmit and receive configuration which have the same polarization. In the example of FIG. 30, node B may communicate its FD capability and the supported reciprocity feature, however, the reciprocity is retained by antenna switching and therefore is synchronized with a switching pattern of node A. In the case of FIG. 31, node B may communicate its FD capability and indicate an unrestricted support of the reciprocity feature.

### GENERAL

Although the respective aspects and embodiments of the inventive approach have been described separately, it is noted that each of the aspects/embodiments may be implemented independent from the other, or some or all of the aspects/embodiments may be combined.

In the above embodiments, the inventive concept has been described with reference to an uplink, UL, or downlink, DL, scenario, however, the present invention is not limited to the such scenarios but is equally applicable to an sidelink, SL, scenario for communicating data between two UEs.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a RAN network entity, like the gNB, comprises one or more of the following: a macro cell base station, or a small cell base station, or a central unit of a base station, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 31 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] A. Sahai, G. Patel, C. Dick, and A. Sabharwal, “On the impact of phase noise on active cancelation in wireless full-duplex,” Vehicular Technology, IEEE Transactions on, vol. 62, no. 9, Nov. 2013.
[2] J. I. Choi, M. Jain, K. Srinivasan, P. Levis, and S. Katti, “Achieving single channel, full duplex wireless communication,” in Proceedings of the sixteenth annual international conference on Mobile computing and networking, ser. MobiCom '10, 2010.
[3] M. A. Khojastepour, K. Sundaresan, S. Rangarajan, X. Zhang, and S. Barghi, “The case for antenna cancellation for scalable full-duplex wireless communications,” in Proceedings of the 10th ACM Workshop on Hot Topics in Networks, ser. HotNets-X. ACM, 2011, pp. 17:1-17:6.
[4] M. Jain, J. I. Choi, T. Kim, D. Bharadia, S. Seth, K. Srinivasan, P. Levis, S. Katti, and P. Sinha, “Practical, real-time, full duplex wireless,” in Proceedings of the 17th annual international conference on Mobile computing and networking, ser.

MobiCom '11, 2011.
[5] L. Laughlin, M. Beach, K. Morris, and J. Haine, “Optimum single antenna full duplex using hybrid junctions,” Selected Areas in Communications, IEEE Journal on, vol. 32, no. 9, Sep. 2014.
[6] L. Laughlin, M. Beach, K. Morris, and J. Hainey, “Electrical balance isolation for flexible duplexing in 5g mobile devices,” in Communication Workshop (ICCW), 2015 IEEE International Conference on, June 2015.
[7] L. Laughlin, C. Zhang, M. Beach, K. Morris, and J. Haine, “A widely tunable full duplex transceiver combining electrical balance isolation and active analog cancellation,” in Vehicular Technology Conference (VTC Spring), 2015 IEEE 81st, May 2015.
[8] E. Everett, M. Duarte, C. Dick, and A. Sabharwal, “Empowering full-duplex wireless communication by exploiting directional diversity,” in Signals, Systems and Computers (ASILOMAR), 2011 Conference Record of the Forty Fifth Asilomar Conference on, 2011, pp. 2002-2006.
[9] E. Everett, A. Sahai, and A. Sabharwal, “Passive self-interference suppression for full-duplex infrastructure nodes,” Wireless Communications, IEEE Transactions on, vol. PP, no. 99, pp. 1-15, 2014.
[10] T. Dinc, A. Chakrabarti, and H. Krishnaswamy, “A 60 GHz same-channel full-duplex CMOS transceiver and link based on reconfigurable polarization-based antenna cancellation,” in Radio Frequency Integrated Circuits Symposium (RFIC), 2015 IEEE, 2015, pp. 31-34.
[11] A. Sahai, G. Patel, and A. Sabharwal, “Pushing the limits of full-duplex: Design and real-time implementation,” Rice University, Technical report, 7 2011.
[12] D. Korpi, S. Venkatasubramanian, T. Riihonen, L. Anttila, S. Otewa, C. lcheln, K.
Haneda, S. Tretyakov, M. Valkama, and R. Wichman, “Advanced self-interference cancellation and multiantenna techniques for full-duplex radios,” in Signals, Systems and Computers, 2013 Asilomar Conference on, 11 2013, pp. 3-8.
[13] M. Heino, D. Korpi, T. Huusari, E. Antonio-Rodriguez, S. Venkatasubramanian, T. Riihonen, L. Anttila, C. lcheln, K. Haneda, R. Wichman, and M. Valkama, “Recent advances in antenna design and interference cancellation algorithms for in-band full duplex relays,” Communications Magazine, IEEE, vol. 53, no. 5, pp. 91-101, 5 2015.
[14] K. Kolodziej, P. Hurst, A. Fenn, and L. Parad, “Ring array antenna with optimized beamformer for simultaneous transmit and receive,” in Antennas and Propagation Society International Symposium (APSURSI), 2012 IEEE, 7 2012, pp. 1-2.
[15] N. A. Estep, D. L. Sounas, J. Soric, and A. Alu, “Magnetic-free non-reciprocity and isolation based on parametrically modulated coupled-resonator loops,” Nat Phys, vol. 10, no. 12, pp. 923-927, 2014. [Online]. Available: http://dx.doi.org/10.1038/nphys3134.
[16] D. Bharadia, E. McMilin, and S. Katti, “Full duplex radios,” in Proceedings of the ACM SIGCOMM 2013 conference on SIGCOMM, ser. SIGCOMM '13, 2013.
[17] R. Askar, T. Kaiser, B. Schubert, T. Haustein, and W. Keusgen, “Active self-interference cancellation mechanism for full-duplex wireless transceivers,” in Cognitive Radio Oriented Wireless Networks and Communications (CROWNCOM), 2014 9th International Conference on, June 2014.
[18] R. Askar, B. Schubert, W. Keusgen, and T. Haustein, “Full-Duplex wireless transceiver in presence of I/O mismatches: Experimentation and estimation algorithm,” in IEEE GC 2015 Workshop on Emerging Technologies for 5G Wireless Cellular Networks—4th International (GC′15—Workshop—ETSG), San Diego, USA, December 2015.
[18] M. Duarte and A. Sabharwal, “Full-duplex wireless communications using off-the-shelf radios: Feasibility and first results,” in Signals, Systems and Computers (ASILOMAR), 2010 Conference Record of the 44th Asilomar Conference on, 2010, pp. 1558-1562.
[20] M. Duarte, C. Dick, and A. Sabharwal, “Experiment-driven characterization of full-duplex wireless systems,” Wireless Communications, IEEE Transactions on, vol. 11, no. 12, December 2012.
[21] R. Askar, N. Zarifeh, B. Schubert, W. Keusgen, and T. Kaiser, “I/O imbalance calibration for higher self-interference cancellation levels in full-duplex wireless transceivers,” in 5G for Ubiquitous Connectivity (5GU), 2014 1st International Conference on, 2014, pp. 92-97.
[22] D. Korpi, L. Anttila, V. Syrjala, and M. Valkama, “Widely linear digital self-interference cancellation in direct-conversion full-duplex transceiver,” Selected Areas in Communications, IEEE Journal on, vol. 32, no. 9, pp. 1674-1687, 9 2014.
[23] E. Ahmed, A. Eltawil, and A. Sabharwal, “Self-interference cancellation with nonlinear distortion suppression for full-duplex systems,” in Signals, Systems and Computers, 2013 Asilomar Conference on, 2013, pp. 1199-1203.
[24] D. Korpi, T. Riihonen, V. Syrjala, L. Anttila, M. Valkama, and R. Wichman, “Full-duplex transceiver system calculations: Analysis of ADC and linearity challenges,” Wireless Communications, IEEE Transactions on, vol. PP, no. 99, pp. 1-1, 2014.
[25] L. Anttila, D. Korpi, V. Syrjala, and M. Valkama, “Cancellation of power amplifier induced nonlinear self-interference in full-duplex transceivers,” in Signals, Systems and Computers, 2013 Asilomar Conference on, 2013, pp. 1193-1198.
[26] A. Sahai, G. Patel, C. Dick, and A. Sabharwal, “Understanding the impact of phase noise on active cancellation in wireless full-duplex,” in Signals, Systems and Computers (ASILOMAR), 2012 Conference Record of the Forty Sixth Asilomar Conference on, 11 2012, pp. 29-33.
[27] E. Ahmed, A. Eltawil, and A. Sabharwal, “Self-interference cancellation with phase noise induced ici suppression for full-duplex systems,” in Global Communications Conference (GLOBECOM), 2013 IEEE, 2013, pp. 3384-3388.
[28] Y. Hua, Y. Ma, P. Liang, and A. Cirik, “Breaking the barrier of transmission noise in full-duplex radio,” in Military Communications Conference, MILCOM 2013-2013 IEEE, 11 2013, pp. 1558-1563.
[29] D. Bharadia, K. R. Joshi, and S. Katti, “Full duplex backscatter,” in Proceedings of the Twelfth ACM Workshop on Hot Topics in Networks, ser. HotNets-XII. ACM, 2013, pp. 4:1-4:7.
[30] D. Bharadia and S. Katti, “Full duplex MIMO radios,” in 11th USENIX Symposium on Networked Systems Design and Implementation (NSDI 14). USENIX Association, April 2014.
[31] A. Gholian, Y. Ma, and Y. Hua, “A numerical investigation of all-analog radio self-interference cancellation,” in Signal Processing Advances in Wireless
[32] Communications, 2014 IEEE 15th International Workshop on, 2014, pp. 459-463. Y. Hua, Y. Li, C. Mauskar, and Q. Zhu, “Blind digital tuning for interference cancellation in fullduplex radio,” in Signals, Systems and Computers, 2014 48th Asilomar Conference on, 11 2014, pp. 1691-1695.
[33] Y. Hua, Y. Ma, A. Gholian, Y. L₁, A. C. Cirik, and P. Liang, “Radio self-interference cancellation by transmit beamforming, all-analog cancellation and blind digital tuning,” Signal Processing, vol. 108, 2015.
[34] J. McMichael and K. Kolodziej, “Optimal tuning of analog self-interference cancellers for fullduplex wireless communication,” in Communication, Control, and Computing (Allerton), 50th Annual Allerton Conference on, 10 2012, pp. 246-251.
[35] K. Kolodziej, J. McMichael, and B. Perry, “Adaptive RF canceller for transmit-receive isolation improvement,” in Radio and Wireless Symposium (RWS), 2014 IEEE, 1 2014, pp. 172-174.
[36] R. Askar, F. Baum, W. Keusgen, and T. Haustein. Decoupling-based self-interference cancellation in MIMO full-duplex wireless transceivers. pages 1-6. IEEE, 2018.
[37] R. Askar, A. Hamdan, W. Keusgen, and T. Haustein. Analysis of utilizing lossless networks for self-interference cancellation purpose. pages 1-6. IEEE, 2018.

1. An apparatus for a wireless communication network,
wherein the apparatus is to communicate with one or more entities in the wireless communication network using a plurality of different communication channels, the plurality of communication channels comprising at least a first communication channel and a second communication channel,
wherein the apparatus is to transmit on one of the first and second communication channels and, at the same time, is to receive the other one of the first and second communication channels, and
wherein, for exploiting a reciprocity of the first and second communication channels, the apparatus is to switch between
simultaneously transmitting over the first communication channel and receiving over the second communication channel, and
simultaneously transmitting over the second communication channel and receiving over the first communication channel.

2. The apparatus of claim 1, wherein, for exploiting the reciprocity of the first and second communication channels, the apparatus is to repeatedly perform the switching, e.g., in accordance with one or more of the following:
predefined pattern,
a pattern defined based on channel properties,
a pattern defined based on network demands and restrictions
one or more operation modes, e.g., backward compatibility modes such as conventional TDD or shared-antenna FD.

3. The apparatus of claim 1, wherein, for transmitting over the first and second communication channels, the apparatus is to use respective channel estimates for the first and second communication channels acquired when receiving over the first and second communication channels.

4. The apparatus of claim 3, wherein
during a first time, the apparatus is to
transmit over the first communication channel and receive over the second communication channel simultaneously, and
estimate one or more channel properties of the second communication channel,
during a second time, the apparatus is to
transmit over the second communication channel and receive over the first communication channel simultaneously, and
estimate one or more channel properties of the first communication channel, and
at further times following the second time, the apparatus is to
transmit over the first communication channel using the one or more channel properties estimated for the first communication channel, and/or
transmit over the second communication channel using the one or more channel properties estimated for the second communication channel.

5. The apparatus of claim 3, wherein the apparatus is to use the one or more channel estimates for the first communication channel during a certain time period, e.g., a coherence time of the first communication channel, and/or the one or more channel estimates for the second communication channel during a certain time period, e.g. a coherence time of the second communication channel.

6. The apparatus of claim 3, wherein the apparatus is to use the one or more channel estimates for the first communication channel acquired during operation of the first communication channel into one direction for transmission over the first communication channel into the opposite direction within a certain time period, e.g., a coherence time of the first communication channel, and/or the one or more channel estimates for the second communication channel acquired during operation of the second communication channel into one direction for transmission over the second communication channel into the opposite direction within a certain time period, e.g., a coherence time of the second communication channel.

7. The apparatus of claim 1, wherein the apparatus comprises one or more antennas and is to simultaneously transmit and receive on a plurality of different frequency bands, the plurality of different frequency bands comprising at least a first frequency band and a second frequency band,
wherein, for simultaneously transmitting over the first communication channel and receiving over the second communication channel, the first communication channel comprises a first frequency band and the second communication channel comprises a second frequency band, and
wherein, for simultaneously transmitting over the second communication channel and receiving over the first communication channel, the first communication channel comprises the second frequency band and the second communication channel comprises the first frequency band.

8. The apparatus of claim 1, wherein the apparatus comprises a plurality of antennas,
wherein, for simultaneously transmitting over the first communication channel and receiving over the second communication channel, the first communication channel comprises one of the plurality of antennas and the second communication channel comprises another one of the plurality of antennas, and
wherein, for simultaneously transmitting over the second communication channel and receiving over the first communication channel, the first communication channel comprises the other one of the plurality of antennas and the second communication channel comprises the one of the plurality of antennas.

9. The apparatus of claim 1, wherein the plurality of antennas comprises one or more of the following:
different antennas,
different subsets of antenna elements, or
different combinations of antenna elements.

10. The apparatus of claim 8, wherein the first and second antennas comprise one or more of the following:
mutually polarized antennas,
mutually polarized antenna panels, each antenna panel comprising one or more antenna elements,
one or more mutually polarized antenna elements of a common antenna panel, physically separate antenna panels, each antenna panel comprising one or more antenna elements,
one or more antenna elements of a common antenna panel.

11. The apparatus of claim 3, wherein, for estimating the first and second communication channels, the apparatus is to perform one or more of the following:
measure one or more reference signals received from the one or more entities over the first and second communication channels and estimate the first and second communication channel using the measurement of the reference signals,
transmit one or more reference signals over the first and second communication channels to the one or more entities, e.g., to allow the one or more entities to acquire channel state information and return it to the apparatus,
transmit one or more reference signals over the first and second communication channels, receive from the one or more entities estimates for the first and second communication channel acquired by the one or more entities using a measurement of the reference signals transmitted by the apparatus, and estimate the first and second communication channel using the estimates received from the one or more entities.

12. The apparatus of claim 3, wherein the apparatus is to use the estimates for a beamforming procedure on the first and second communication channels, like beam management, beam correspondence, and/or precoding.

13. The apparatus of claim 12, wherein
in case the apparatus is not capable to acquire the estimates or in case the estimates are judged to be not reliable, the apparatus is to request from the one or more entities assistance information for the beamforming procedure, or
responsive to request from the one or more entities, the apparatus is to provide to the one or more entities assistance information for the beamforming procedure.

14. The apparatus of claim 12, wherein
the apparatus comprises a plurality of beamforming units, the plurality of beamforming units comprising at least a first beamforming unit associated with the first communication channel and a second beamforming unit associated with the second communication channel,
in case the apparatus is not capable to acquire the estimates for one of the first and second communication channels or in case the estimates for one of the first and second communication channels are judged to be not reliable, the apparatus is to request form the one or more entities assistance information for the beamforming procedure to be used by the beamforming unit associated with the one communication channel.

15. The apparatus of claim 13, wherein the assistance information for the beamforming procedure indicates or signals one or more of the following:
the transmit and/or receive antenna ports associated with the first and second communication channels,
the beam for one of the communication channels and/or the beam pair for both communication channels being swept by a beam management procedure,
the measurements of the beam for one of the communication channels and/or the beam pair for both communication channels,
the transmit and/or receive beam for one of the communication channels and/or the beam pair for both communication channels determined by a beam correspondence procedure,
the precoder selected by the apparatus and/or a decoder to be selected at the one or more entities,
information for coordinating the precoder at the apparatus and the decoder at the one or more entities.

16. The apparatus of claim 13, wherein the assistance information is signaled using one or more configured or preconfigured messages, like Signaling Extensions Flexible Antenna Port Mapping, S4FAPM, signaling messages.

17. The apparatus of claim 16, wherein the one or more configured or preconfigured messages comprise one or more configuration messages signaling one or more of the following:
how antenna port configurations and associated antenna patterns are be reported,
what assistance information is to be reported,
a format of the one or more configured or preconfigured messages.

18. The apparatus of claim 16, wherein the one or more configured or preconfigured messages comprise one or more capability messages signaling one or more of the following:
current capabilities of the apparatus and/or the one or more entities,
current settings of the apparatus and/or the one or more entities, and
acknowledgements of configuration commands.

19. The apparatus of claim 18, wherein the capabilities of the apparatus and/or the one or more entities comprise one or more of the following:
capability information for supporting use of the one or more configured or preconfigured messages, like information regarding parameters of observation capabilities and associated parameterization, metrics and measurement uncertainties,
information about a message space configuration supported by the apparatus and/or the one or more entities,
information about features and assistance modes supported by the apparatus and/or the one or more entities, like one or more of the following antenna port properties and/or configurations:
an inter-band distance,
a system bandwidth per band, like the available bandwidth over all component carriers used for UL and/or DL,
a number of antenna elements, a spacing and geometric distribution of the antenna elements,
an effective aperture and an effective beamwidth,
beam steering angles and ranges,
an effective temporal and angular resolution,
an antenna array orientation, direction, directivity, spatial pattern overlaps for each antenna port,
a number of antenna port configuration states used by the apparatus,
one or more patterns of switching between antenna port configuration states, like antenna port mapping configurations,
an uplink/downlink relation between antenna port configuration states,
a transmission/reception relation between antenna port configuration states,
wherein the relation refers to the same and/or different antenna port configuration states, and/or
wherein the relation refers to a mapping to particular radio resources, e.g.,
in the spectrum domain: carriers, like for FDD, TDD, one or more bandwidth parts, BWP, one or more bands, like licensed, unlicensed, and/or band combinations,
in the time domain: one or more radio frame, one or more slots, one or more OFDM symbols, etc.
in the spatial domain: one or more spatial beams, one or more antenna radiation patterns, one or more polarizations, direction of arrival, DoA, direction of departure, DoD,
antenna elements: center of radiation reference point, one or more sub-arrays, a proximity of antenna elements, a cross-coupling between antenna ports,
a similarity and/or a dissimilarity of the communication channels and/or components contributing to the communication channels: allowing one of the communication channels to predict changes in another one of the communication channels in case the similarity meets an associated threshold and/or the dissimilarity meets an associated threshold.

20. The apparatus of claim 16, wherein the one or more configured or preconfigured messages comprise one or more command messages signaling one or more commands to be executed or recommended to be executed by the apparatus and/or the one or more entities.

21. The apparatus of claim 1, comprising:
at least one RF transmitter chain;
at least one RF receiver chain,
an RF circuit and an antenna unit for transmitting and receiving radio signals; and
a switching circuit connected between the RF transmitter chain and the RF circuit and between the RF receiver chain and the RF circuit,
wherein the switching circuit is to selectively connect
for simultaneously transmitting over the first communication channel and receiving over the second communication channel, the RF transmitter chain to a first connection or terminal of the RF circuit, and the RF receiver chain to a second connection or terminal of the RF circuit, and
for simultaneously transmitting over the second communication channel and receiving over the first communication channel, the RF transmitter chain to the second connection or terminal of the RF circuit, and the RF receiver chain to the first connection or terminal of the RF circuit.

22. The apparatus of claim 21, wherein the RF circuit comprises:
one or more antennas; and
a plurality of filters, the plurality of filters comprising at least a first filter defining the first frequency band and a second filter defining the second frequency band,
wherein the switching circuit is to selectively connect
for simultaneously transmitting over the first communication channel and receiving over the second communication channel, the RF transmitter chain to the first filter of the RF circuit, and the RF receiver chain to the second filter of the RF circuit, and
for simultaneously transmitting over the second communication channel and receiving over the first communication channel, the RF transmitter chain to the second filter of the RF circuit, and the RF receiver chain to the first filter of the RF circuit, or
for simultaneously transmitting over the first communication channel and receiving over the second communication channel, the RF transmitter chain to a first filter terminal of a frequency duplexing filter, and the RF receiver chain to a second filter terminal of the frequency duplexing filter, and
for simultaneously transmitting over the second communication channel and receiving over the first communication channel, the RF transmitter chain to the second filter terminal of the frequency duplexing filter, and the RF receiver chain to the first filter terminal of the frequency duplexing filter.

23. The apparatus of claim 21, wherein the transceiver circuit comprises:
a plurality of antennas, the plurality of antennas comprising at least a first antenna and a second antenna;
wherein the switching circuit is to selectively connect
for simultaneously transmitting over the first communication channel and receiving over the second communication channel, the RF transmitter chain to the first antenna of the RF circuit, and the RF receiver chain to the second antenna of the RF circuit, and
for simultaneously transmitting over the second communication channel and receiving over the first communication channel, the RF transmitter chain to the second antenna of the RF circuit, and the RF receiver chain to the first antenna of the RF circuit.

24. The apparatus of claim 21, wherein the switching circuit comprises:
a plurality of inputs, the plurality of inputs comprising at least a first input connected to the RF transmitter chain and a second input connected to the RF receiver chain;
a plurality of outputs, the plurality of outputs comprising at least a first out connected to the first connection of the RF circuit and a second output connected to the second connection of the RF circuit; and
a plurality of switching elements to selectively connect the plurality of inputs and the plurality of outputs.

25. The apparatus of claim 24, wherein the switching circuit is to connect
for simultaneously transmitting over the first communication channel and receiving over the second communication channel, the first input to the first output and the second input to the second output, and
for simultaneously transmitting over the second communication channel and receiving over the first communication channel, the first input to the second output and the second input to the first output.

26. The apparatus of claim 21, wherein, when the apparatus does not operate in simultaneously transmitting and receiving mode, the switching circuit is to
provide no connection to the second connection of the RF circuit, and, for simultaneously transmitting over the first communication channel and receiving over the second communication channel, connect the RF transmitter chain to the first connection of the RF circuit, and, for simultaneously transmitting over the second communication channel and receiving over the first communication channel, connect the RF receiver chain to the first connection of the transceiver circuit, or
connect the RF transmitter chain to the first connection of the RF circuit, and the RF receiver chain to the second connection of the RF circuit, wherein, for simultaneously transmitting over the first communication channel and receiving over the second communication channel, the apparatus is to transmit, and for simultaneously transmitting over the second communication channel and receiving over the first communication channel, the apparatus is to receive.

27. The apparatus of claim 21, wherein the switching circuit comprises:
a passive, non-reciprocal device connected between one of the first and second connections of the RF circuit and the RF transmitter chain,
wherein, to provide backward compatibility to a shared-transmit-and-receive antenna in FD mode, the switching circuit is to connect the RF transmitter chain via the passive, non-reciprocal device to the first connection of the transceiver circuit, and the RF receiver chain to the passive, non-reciprocal device.

28. The apparatus of claim 21, wherein the apparatus is configured to
estimate a link quality of a communication link with the one or more entities when simultaneously transmitting over the first communication channel and receiving over the second communication channel and when simultaneously transmitting over the second communication channel and receiving over the first communication channel, and
select for a communication with the one or more entities, a simultaneous transmission over the first communication channel and reception over the second communication channel or a simultaneous transmission over the second communication channel and reception over the first communication channel dependent which configuration yielded the higher link quality.

29. The apparatus of claim 1, wherein the apparatus and/or the one or more entities comprise one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and needing input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a base station, e.g. a macro or small cell base station, or a central unit of a base station, or a distributed unit of a base station, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a transceiver, or any sidelink capable network entity.

30. The apparatus of claim 1, wherein
one or more of the entities comprise a full-duplex node comprising a single shared transmit and receive antenna or dedicated transmit and receive antennas,
the apparatus is to receive a full-duplex node an indication whether the a full-duplex node comprises an apparatus of claim 1,
responsive to an indication that the a full-duplex node comprises an apparatus of claim 1,
the apparatus, for simultaneously transmitting and receiving to/from the a full-duplex node, is to perform the switching,
responsive to an indication that the a full-duplex node comprises no apparatus of claim 1, the apparatus, for simultaneously transmitting and receiving to/from the full-duplex node, is to simultaneously transmit over the first communication channel and receive over the second communication channel and/or simultaneously transmit over the second communication channel and receive over the first communication channel.

31. A wireless communication system, comprising:
one or more devices for communicating with one or more access points of a radio access network and/or with one or more further devices,
wherein the one or more devices and/or the one or more access points and/or the one or more further devices comprise an apparatus of claim 1.

32. The wireless communication system of claim 21, wherein the one or more further devices comprise one of more of the following:
a half-duplex TDD or FDD node,
a full-duplex node comprising one or more dedicated receive and transmit antennas, like a TDD node
a full-duplex node comprising one or more antennas, like a FDD node.

33. A method for operating an apparatus for a wireless communication network, the method comprising:
communicating with one or more entities in the wireless communication network using a plurality of different communication channels, the plurality of communication channels comprising at least a first communication channel and a second communication channel,
transmitting on one of the first and second communication channels and, at the same time, is to receive the other one of the first and second communication channels, and
for exploiting a reciprocity of the first and second communication channels, switching between
simultaneously transmitting over the first communication channel and receiving over the second communication channel, and
simultaneously transmitting over the second communication channel and receiving over the first communication channel.

34. A non-transitory digital storage medium having a computer program stored thereon to perform the method for operating an apparatus for a wireless communication network, the method comprising:
communicating with one or more entities in the wireless communication network using a plurality of different communication channels, the plurality of communication channels comprising at least a first communication channel and a second communication channel,
transmitting on one of the first and second communication channels and, at the same time, is to receive the other one of the first and second communication channels, and
for exploiting a reciprocity of the first and second communication channels, switching between
simultaneously transmitting over the first communication channel and receiving over the second communication channel, and
simultaneously transmitting over the second communication channel and receiving over the first communication channel,
when said computer program is run by a computer.
